(19) United States
(12) Patent Application Publication
(10) Pub. No.: US 2022/0069681 A1
(43) Pub. Date: Mar. 3, 2022

(54) METHOD FOR WINDING A HEAVY GAUGE TOROIDAL COIL OF AN ELECTRIC MACHINE

(71) Applicant: Linear Labs, Inc., Fort Worth, TX (US)

(72) Inventors: Michael Van Steenburg, Fort Worth, TX (US); Adam Mengestab, Dallas, TX (US); Anto Joseph Barigala Charles Paulraj, Arlington, TX (US); Cosmin Gheorghe Barbu, Coppell, TX (US); Andrei V. Popov, Azle, TX (US); Fred E. Hunstable, Granbury, TX (US); Erik Hatch, Frisco, TX (US)

(21) Appl. No.: 17/412,117

(22) Filed: Aug. 25, 2021

Related U.S. Application Data
(63) Continuation-in-part of application No. 17/003,905, filed on Aug. 26, 2020.
(60) Provisional application No. 63/122,364, filed on Dec. 7, 2020.

(51) Int. Cl. H02K 15/04; H02K 15/00; H02K 3/28; H02K 1/27

(52) U.S. Cl. CPC H02K 15/0435; H02K 1/278; H02K 3/28; H02K 15/0037

(57) ABSTRACT

Disclosed are various embodiments for winding heavy gauge coils of electric machines having fractional concentrated windings including one of more of positioning the middle of a predetermined length of heavy gauge wire in contact with an inclined chamfer in a face of a center projection of a fixture tool, simultaneously bending both ends of the heavy gauge wire in a first direction using the center projection to compete the first turn of the coil, simultaneously bending both ends of the heavy gauge wire in a seconding direction using the center projection to complete a second turn of the coil; continuing to simultaneously bend the heavy gauge wire in the first direction and the seconding direction until the required number of even or odd turns are completed, removing one of the adjoining right-angle faces of the fixture tool; and sliding the coiled heavy gauge wire off of the center projection.

### CROSS-REFERENCE TO RELATED APPLICATIONS

This application claims the benefit of the filing date of U.S. provisional application Ser. No. 63/122,364, filed Dec. 7, 2020, entitled “METHOD FOR WINDING A HEAVY GAUGE TOROIDAL COIL OF AN ELECTRIC MACHINE,” and is a Continuation-in-Part of U.S. application Ser. No. 17/003,905, filed Aug. 26, 2020, entitled “MULTI-TUNNEL ELECTRIC MACHINE.” The disclosures of which are herein incorporated by reference for all purposes.

### TECHNICAL FIELD

The invention relates in general to new and improved methods for bobbin winding heavy gauge toroidal coils of electric machines having fractional-slot concentrated windings and in particular, to electric machines having a unique arrangement of rotors for producing rotary motion or generating electrical power from rotary motion input.

### BACKGROUND INFORMATION

Electric motors use electrical energy to produce mechanical energy, typically through the interaction of magnetic fields and current-carrying conductors. The conversion of electrical energy into mechanical energy by electromagnetic means was first demonstrated by the British scientist Michael Faraday in 1821 and later quantified by the work of Hendrik Lorentz.

A magnetic field is generated when electric charge carriers such as electrons move through space or within an electrical conductor. In a conventional electric motor, a central core (commonly known as the rotor) of tightly wrapped current carrying material creates magnetic poles which rotate at high speed between the fixed poles of a magnet (commonly known as the stator) when an electric current is applied. The central core is normally coupled to a shaft which rotates with the rotor. The shaft may be used to drive gears and wheels in a rotary machine or convert rotational motion into motion in a straight line. With conventional electric motors a pulsed electrical current of sufficient magnitude must be applied to produce a given torque or horsepower output.

Generators are usually based on the principle of electromagnetic induction, which was discovered by Michael Faraday in 1831. Faraday discovered that when an electrical conducting material, such as coils of copper wire, are moved through a magnetic field, or vice versa, an electric current will begin to flow through that moving conducting material. In this situation, the coils of wire are called the armature, because they are moving with respect to the stationary magnets, which are called the stator. Typically, the moving component is called the rotor or armature and the stationary components are called the stator. The power generated is a function of flux strength, conductor size, number of pole pieces, and motor speed in revolutions per minute (RPM).

In motors or generators, some form of energy drives the rotation of the rotor. As energy becomes scarcer and more expensive, what is needed are more efficient motors and generators to reduce energy consumption and hence reduce costs.

### SUMMARY

In response to this and other problems, this patent application is an expansion of previous patents and patent applications that discussed using methods and systems of increasing flux density in electric machines by using permanent magnet and multiple rotors to form a magnetic torque tunnel.

These and other features, and advantages, will be more clearly understood from the following detailed description taken in conjunction with the accompanying drawings which illustrate a novel permanent magnetic rotating flux machine having manufacturing and operational advantages over conventional electric machines For instance, the flux density of the disclosed electric machine is very high, and the number of poles may be increase without reducing the permanent magnetic force per pole enabling higher power densities. Further, since torque increases with the number of poles for a constant current a further advantage of the disclosed electric machine is that the large number of poles, with relatively short current pathways, results in a higher torque/weight ratio, a higher power/weight ratio, and lower copper losses than a conventional electric machine and therefore a more efficient electric machine.

### BRIEF DESCRIPTION OF THE DRAWINGS

FIG. 1A1 is an exploded view of one embodiment of an electric machine according to certain aspects of the present disclosure.

FIG. 1A2 is a detailed isometric view of one embodiment of a second axial rotor core illustrating structural components used to position and retain a spider stator inner and a spider stator outer on a center shaft relative to the second axial rotor assembly.

FIG. 1A4 is a detailed isometric view of one embodiment of the first axial rotor core and an inner rotor core illustrating components used to position and retain the first axial rotor core and the inner rotor core on the center shaft.

FIG. 1B1 is an isometric view of one embodiment of a slot defined in a magnetic toroidal cylinder by an inner magnetic cylinder wall and a first axial magnet wall of the electric machine that is wide enough to allow the passage of a support structure, electric wires, and the like.

FIG. 1B2 is an isometric view of one embodiment of the outer stator spider illustrating the outer stator spider coupled to and supporting the stator poles of the coil winding assembly by way of the slot defined in the magnetic toroidal cylinder.

FIG. 1B3 is an exploded isometric view illustrating the outer stator spider coupled to the stator poles of the coil winding assembly.

FIG. 1C1 is an isometric view illustrating a single Halbach Array Torque Tunnel segment.

FIG. 1C2 is an isometric view of a coil situated between a pair of stator poles.

FIG. 1C3a through FIG. 1C3d illustrate various structure elements of a stator pole having two halves.

FIG. 1C4 is an isometric view of the single Halbach Array Torque Tunnel segment of the magnetic toroidal cylinder of FIG. 1C1 and associated stator poles and coils of the coil winding assembly positioned about a portion of the center ring-like core.

FIG. 1C5 is a section view of the single Halbach Array Torque Tunnel segment of FIG. 1C1 and a single stator pole.

FIG. 1C6 is an isometric view of a portion of the magnetic flux circuit of the electric machine.

FIG. 1E1 is an isometric view of one embodiment of a center ring-like core.

FIG. 1E2 is an isometric view of the coils and stator poles associated with one half of a single phase of a 3-phase coil winding assembly.

FIG. 1E3 is an isometric view of the coils and stator poles associated with one half of the coil winding assembly.

FIG. 1E4 is an isometric of a complete coil winding assembly 500 formed by joining the coil winding assembly of FIG. 1E3 with another center core portion also having a full complement of coils and stator poles.

FIG. 1E5 is a top-right isometric view of a fly wound bobbin coil.

FIG. 1E6 is a side view of the fly wound bobbin coil of FIG. 1E5.

FIG. 1E7 is a top-left isometric view of the fly wound bobbin coil of FIG. 1E5.

FIG. 1E8 is a bottom-right view of the fly wound bobbin coil of FIG. 1E5.

FIG. 1E9 is an isometric view of a fixture tool for a double fly winding bobbin coil.

FIG. 1E10a is a side view of the fixture tool of FIG. 1E9.

FIG. 1E10b is an end view of the fixture tool of FIG. 1E9.

FIG. 1E11 are isometric views of Part A and Part B of the fixture tool of FIG. 1E9.

FIG. 1E12 are alternative isometric views of Part A and Part B of the fixture tool of FIG. 1E9.

FIG. 1E13 are a side view and an end view of the fixture tool of FIG. 1E9 illustrating the starting step in the coil winding process.

FIG. 1E14 are a side view and corresponding end view of the fixture tool of FIG. 1E9 illustrating the coil winding process after the first turn of the coil winding process has been completed.

FIG. 1E15 are a side view and corresponding end view of the fixture tool of FIG. 1E9 illustrating the coil winding process at the start of the second turn in the coil winding process.

FIG. 1E16 are a side view and corresponding end view of the fixture tool of FIG. 1E9 illustrating the coil winding process after the second turn in the coil winding process has been completed.

FIG. 1E17 are a side view and corresponding end view of the fixture tool of FIG. 1E9 illustrating the coil winding process after the third turn in the coil winding process has been completed.

FIG. 1E18 are a side view and corresponding end view of the fixture tool of FIG. 1E9 illustrating the coil winding process after third turns in the coil winding process have been completed on both sides and a fourth turn has been completed on one side.

FIG. 1E19 is an end view of the fixture tool of the fixture tool of FIG. 1E9 illustrating the coil winding process after six turns in the coil winding process have been completed.

FIG. 1E20 is an end view of the fixture tool of the fixture tool of FIG. 1E9 illustrating the coil winding process after seven turns in the coil winding process have been completed.

FIG. 1F1 is an isometric view of the PCB interconnect board located within the complete coil winding assembly of FIG. 1E4.

FIG. 1F2 is an isometric view of the brushless motor controller coupled to the assembly of FIG. 1E4.

FIG. 1G1 illustrates an array of eight magnets having the same orientation and their stand-alone flux field.

FIG. 1G2 illustrates the corresponding stand-alone flux field of a Halbach Array having eight permanent magnets with 90 degrees orientation change between adjacent magnets.

FIG. 1G3 illustrates the corresponding stand-alone flux field of a Halbach Array having eight permanent magnets with 45 degrees orientation change between adjacent magnets.

FIG. 1G4 illustrates the 45-degree orientation change between adjacent magnets for a Halbach Array having eight permanent magnets.

FIG. 2A is an isometric view of one embodiment of a Torque Tunnel Halbach Array Electric Machine (THEM) according to the principles of the present invention.

FIG. 2B is an isometric view illustrating the first axial rotor assembly and the inner rotor assembly of FIG. 2A.

FIG. 2C is an isometric view illustrating an outer rotor assembly of the Torque Tunnel Halbach Array Electric Machine

FIG. 2D is an isometric view illustrating a Radial Double Rotor Torque Tunnel Halbach Array Electric Machine.

FIG. 2E is an isometric view illustrating a second axial rotor assembly of the Torque Tunnel Halbach Array Electric Machine.

FIG. 2F is an isometric view illustrating an Axial Double Rotor Torque Tunnel Halbach Array Electric Machine.

FIG. 2G is an isometric view illustrating the first axial rotor assembly and inner rotor assembly of FIG. 2B coupled to the outer rotor assembly of FIG. 2C.

FIG. 2H is an isometric view illustrating a coil winding assembly within the rotor assembly of FIG. 2G.

### DETAILED DESCRIPTION

Specific examples of components, signals, messages, protocols, and arrangements are described below to simplify the present disclosure. These are, of course, merely examples and are not intended to limit the invention from that described in the claims. Well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry or mechanisms used to control the rotation of the various elements described herein are omitted, as such control circuits are within the skills of persons of ordinary skill in the relevant art.

When directions, such as upper, lower, top, bottom, clockwise, counterclockwise, are discussed in this disclosure, such directions are meant to only supply reference directions for the illustrated figures and for orientation of components in the figures. The directions should not be read to imply actual directions used in any resulting invention or actual use. Under no circumstances, should such directions be read to limit or impart any meaning into the claims.

Clarification of Terms

The flow of current through a conductor creates a magnetic field. When a current carrying conductor is placed in a magnetic field the current carrying conductor will experience a force. The force that the current carrying conductor experiences is proportional to the current in the wire and the strength of the magnet field that it is placed in. Further, the force that the current carrying conductor experiences will be greatest when the magnetic field is perpendicular to the conductor. For the purposes of this application “flux current” is defined as the rate of current flow through a given conductor cross-sectional area. In some embodiments described herein the source of the magnetic field may be a current flowing in individual coils of a motor winding. In other embodiments, the source of the magnetic field may be a permanent magnet. The magnetic field associated with the permanent magnetic may be visualized as comprising of a plurality of directional magnetic flux lines surrounding the permanent magnet. The magnetic flux lines, often denoted as Φ, or Φ_{B}, are conventionally taken as positively directed from a N pole to a S pole of the permanent magnet. The flux density, often written in bold type as B, in a sectional area A of the magnetic field surrounding the permanent magnet is defined as the magnetic flux Φ divided by the area A and is a vector quantity.

For the purposes of this application “slot fill factor” is the ratio of the cross-section area occupied by copper wire inside the stator slot to the total amount of available space in the empty slot.

For the purposes of this application “slot opening” the size of the gap between the electric machine poles. The larger the opening, the easier it is to insert the wire of the coil. However, a larger slot opening can have a negative impact on the flux path. In contrast, if the opening is too small, then the wire must be wound into the slots turn by turn. This increases the difficulty of inserting and compressing the wire and may reduce the maximum possible fill due to the limited space for tooling especially when slot liners are the primary means of insulation. In practice the minimum opening should be about 2 times the wire diameter, increasing to about 3-4 times the wire diameter for larger coil bundles.

In practice, the amount of material that will fit in a slot depends on the shape of the slot as well as the area and shape of the stator components. The goal in designing slot shape is to maximize capacity for copper and other components while minimizing impact to magnetic flux or manufacturability. Most distributed coil stators with random winding use one of two slot shapes: flat bottom slots with squared or rounded corners, or rounded slots with a radius along the bottom—a kind of teardrop shape. At first glance, the flat bottom slot appears to have higher capacity, but its corners can create challenges.

For example, if a slot liner is used to insulate the stack, it will seldom conform perfectly to the slot and fill in the corners, creating dead space. Even if the liners fit perfectly in the slots, round magnet wire will still not conform to the flat bottom and corners. This also happens in stacks with powder coating: Sharp corners typically lead to buildup of excess powder coating and create similar dead spaces in the slot that cannot be used by the wire.

Rounded bottom slot shapes resolve both problems. A rounded bottom slot provides a consistent surface to which the slot liners conform. The radius can be optimized to allow the wire to fill in more space around the slot edges. Rounded slots can increase maximum slot fill by 5-10 percent.

For the purpose of this application “coil bundle size” refers to the number of turns per coil and the number of wires in parallel. In random coil windings, more turns and more wire in parallel leads to a large coil bundle with many wires crossing each other without a set pattern. Twisting and crossing wires during the winding and inserting process creates extra dead space between individual strands of wire which could result in a faulty coil winding. This reduces the available slot area and can increase the difficulty of insertion. In addition, a large bundle coupled with a small slot opening will increase the difficulty of assembly as the wires may need to be passed through the slot one by one.

For the purpose of this application “wire gauge” refers to the diameter of the coil wire. The diameter of coil wire influences design in two ways. One is total diameter, which has a direct relationship to potential slot fill; the other is actual conductor area—the amount of total diameter that is wire, not insulation—which helps determine how much current can flow through the coil. One way to increase conductor area is to use a larger gauge of conductor to get more copper with less insulation. But as wire size increases, it becomes stiffer and more difficult to handle. Stiff wire is less likely to conform to the slot shape and to other wire in the slot. Using smaller gauge wire will improve ease of handling but will increase the ratio of insulation to conductor. Smaller gauge wires can also result in more turns or parallel wires which increases the risk of wire damage during insertion.

For the purposes of this application “stack aspect ratio” is the relationship of stack length to outside diameter (OD). In general, if the stack length increases while the OD remains the same then the maximum possible slot fill factor will decrease while the difficulty of manufacturing will increase. That is, the higher the aspect ratio, the more difficult the manufacturing process becomes, because of the difficulty in getting the wire to compress in the middle of the stack length on longer parts as the leverage is reduced. For instance, a design with an aspect ratio of about 3.25 will be more difficult to manufacture than one with the same OD and an aspect ration of 2.5 because of the effort required for insertion. In a conventional electric machine, slot fill percentages of about 80% or more may be possible if the aspect ratio is less than about 1.

For the purposes of this application permeability is a measure of the ability of a material to support the formation of magnetic field within the material. That is, permeability is the degree of magnetization that the material will obtain in response to an applied magnetic field.

For the purposes of this application an “inductor” is defined as an electrical component that stores energy in a magnetic field when electric current flows through the inductor. Inductors normally consist of an insulated conducting wire wound into a coil around a core of ferromagnetic material like iron. The magnetizing field from the coil will induce magnetization in the ferromagnetic material thereby increasing the magnetic flux. The high permeability of the ferromagnetic core significantly increases the inductance of the coil. In some embodiments described herein the permeability of the ferromagnetic core may increase the inductance of the coil by a factor of about one thousand or more. The inductance of a circuit depends on the geometry of the current path and the magnetic permeability of nearby materials. For instance, winding a copper wire into a coil increases the number of times the magnetic flux lines link the circuit thereby increasing the field and thus the inductance of the circuit. That is, the more coils the higher the inductance. The inductance also depends on other factors, such as, the shape of the coil, the separation of the coils, and the like. Flux linkage occurs when the magnetic flux lines pass through the coil of wire and its magnitude is determined by the number of coils and the flux density.

For the purposes of this application the axis of the rotor pole may be referred to as the direct-axis or d-axis, whereas the axis in quadrature to the rotor pole may be referred to as the quadrature axis or q-axis. The direct axis is the axis in which flux is produced by the field winding. The quadrature axis is the axis on which torque is produced by the field winding. The effect of the armature (stator) flux on the flux produced by the rotor filed is called the armature reaction flux. The armature reaction flux Φ_{AR} has two components, Φ_{d} along the direct axis and Φ_{q} along the quadrature axis. In AC motors the salient pole field winding rotates, as does the d-axis and q-axis spatially. By convention, the quadrature axis always leads the direct axis electrically by 90 degrees. The d-axis and q-axis inductances are the inductances measured as the flux path passes through the rotor in relation to the magnetic pole. The d-axis inductance is the inductance measured when flux passes through the magnetic poles. The q-axis inductance is the inductance measure when flux passes between the magnetic poles.

For the purposes of this application the term “excitation current” is the current in the stator winding required to generate magnetic flux in the rotor. Permanent magnet machines do not require an excitation current in the stator winding because the motor's magnets already generate a standing magnetic field. The torque-producing current is the current required to generate motor torque. In a permanent magnet machine, the torque-producing current makes up most of the current draw.

When the current flowing through the inductor changes, the time-varying magnetic field induces an Electromotive Force (emf) (voltage) in the conductor, described by Faraday's law of induction . According to Lenz's law, the induced voltage has a polarity which opposes the change in current that created it. As a result, inductors oppose any changes in current through them. For the purposes of this application the term “back electromotive force” or “back emf” is the voltage that occurs in electric motors when there is a relative motion between the stator windings and the rotor's magnetic field. The geometric properties of the rotor will determine the shape of the back emf waveform. The back emf waveforms may be sinusoidal, trapezoidal, triangular, or a combination thereof. Both induction and Permanent Magnet (PM) motors generate back emf waveforms. In an induction machine, the back-emf waveform will decay as the residual rotor field slowly decays because of the lack of a stator field. However, in PM machine the rotor generates its own magnetic field. Therefore, a voltage can be induced in the stator windings whenever the rotor is in motion. The back emf voltage will rise linearly with speed and is a substantial factor in determining maximum operating speed of an electric motor.

In some embodiments, the Permanent Magnet (PM) motor may be a surface permanent magnet motor (SPM). That is, the permanent magnets are affixed to an exterior surface of the rotor. In other embodiments, the PM motor may be an interior permanent magnet motor (IPM). That is, the permanent magnets are inside or encapsulated by the rotor.

An electric motor's torque comprises of magnetic torque and reluctance torque. Magnetic torque is the torque generated by the interaction between the magnet's flux field and the current in the stator winding. Reluctance torque is the force acting on a ferromagnetic material placed in an external magnetic field that causes the ferromagnetic material to align with the external magnetic field, such that, the reluctance is minimized. That is, reluctance torque is the torque generated by the alignment of the rotor shaft to the stator flux field.

For the purposes of this application the term “magnetic saliency” describes the relationship between the rotor's main flux (d-axis) inductance and the main torque-producing (q-axis) inductance. The magnetic saliency may vary depending on the position of the rotor to the stator field, with maximum saliency occurring at 90 electrical degrees from the main flux axis. A Surface Permanent Magnet (SPM) motor has a near unity saliency ratio. That is, the d-axis inductance is approximately equal to the q-axis inductance regardless of the rotor position, because of this SPM motor designs rely significantly, if not completely, on the magnetic torque component to produce torque.

For purposes of this application the term “back iron” may refer to iron or any ferrous-magnetic compound or alloy, such as stainless steel, any nickel or cobalt alloy, electrical steel, laminated steel, laminated silicon steel, or any laminated metal comprising laminated sheets of such material, or a sintered specialty magnetic powder.

System Overview

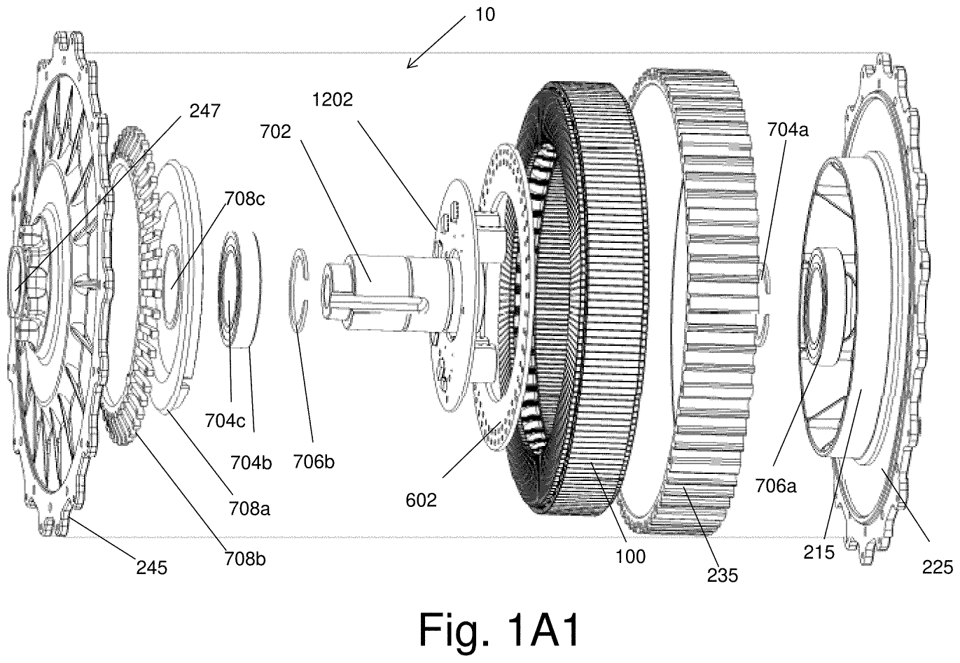

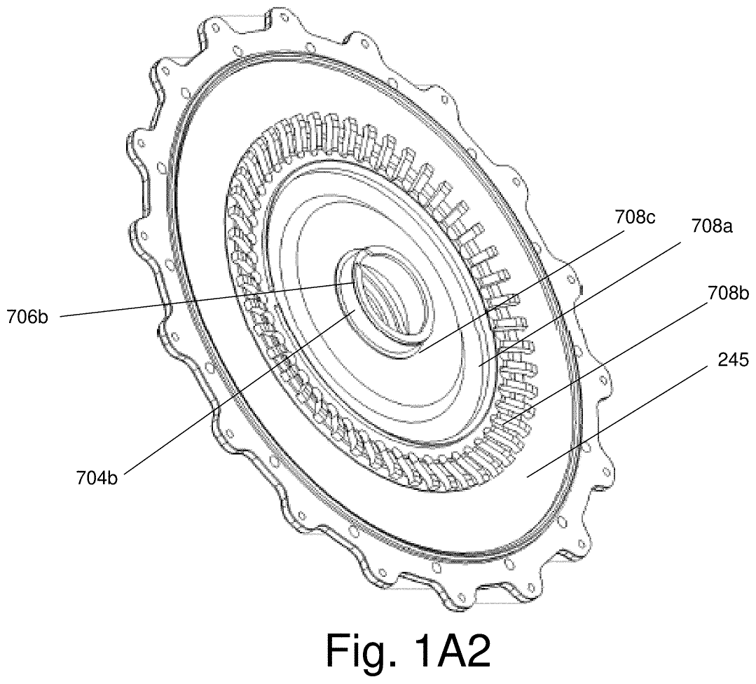

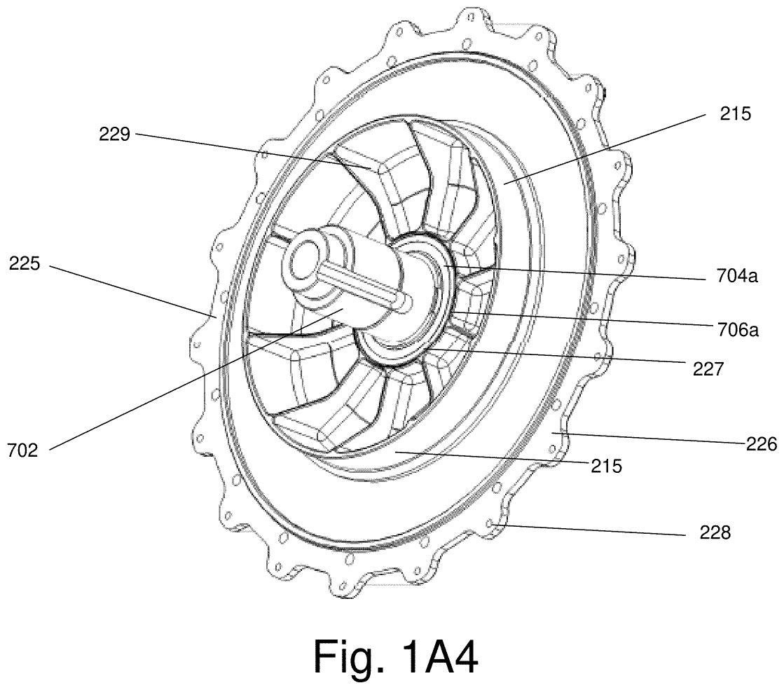

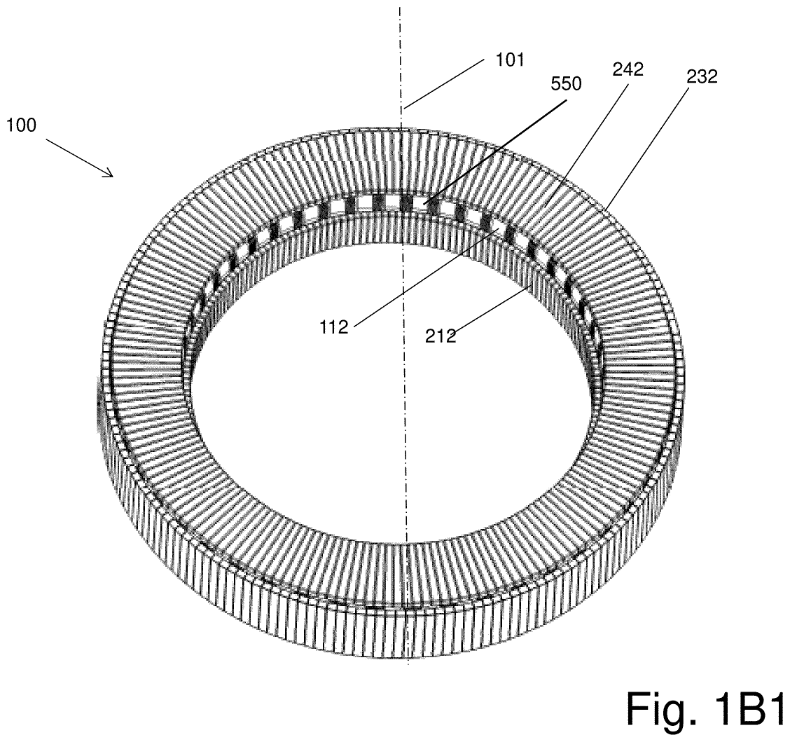

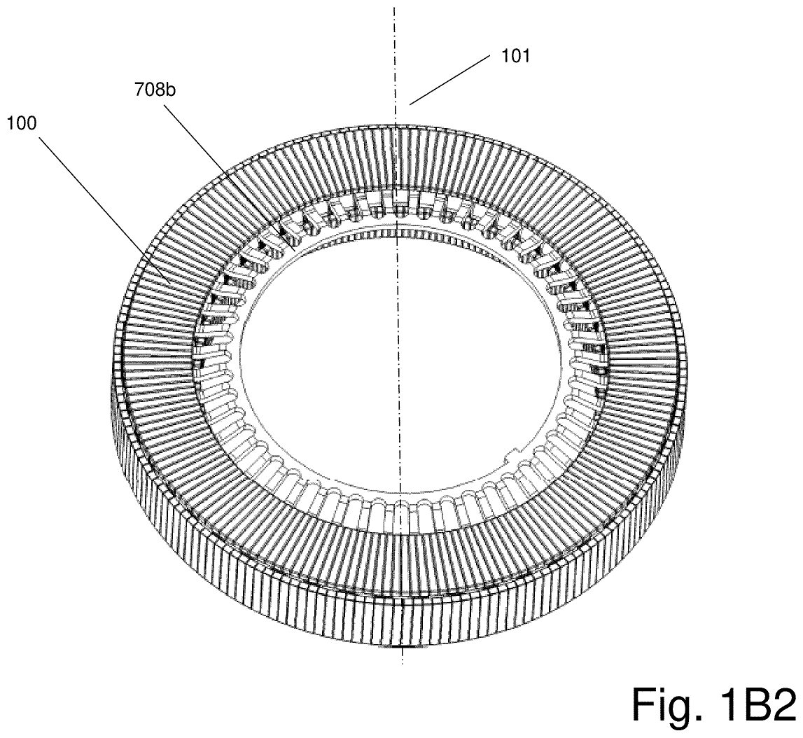

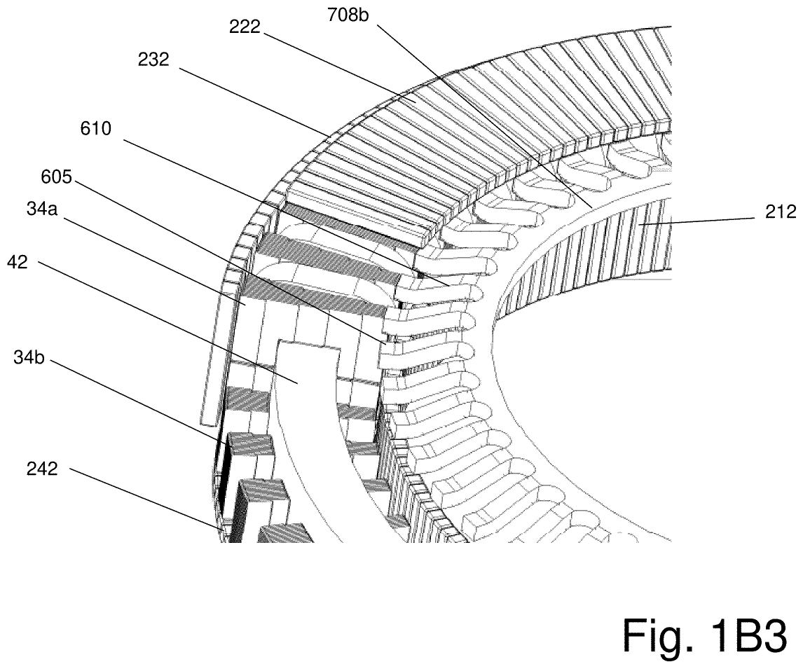

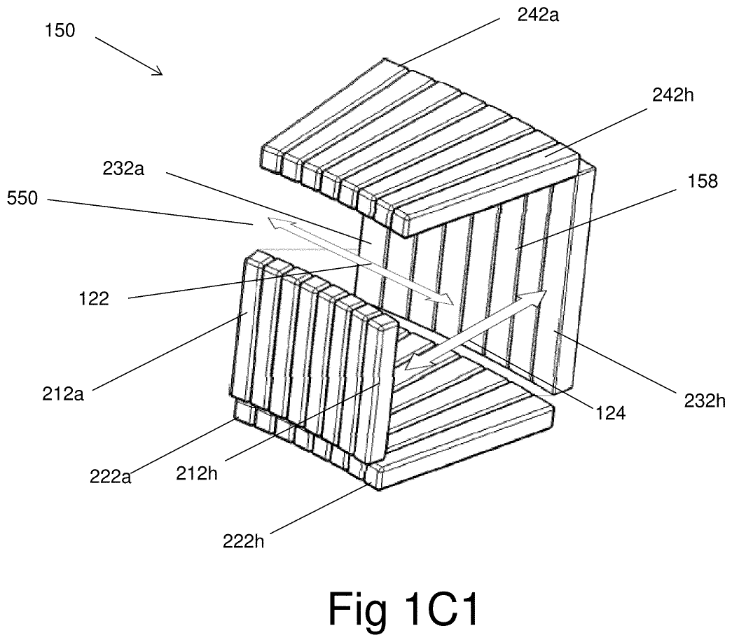

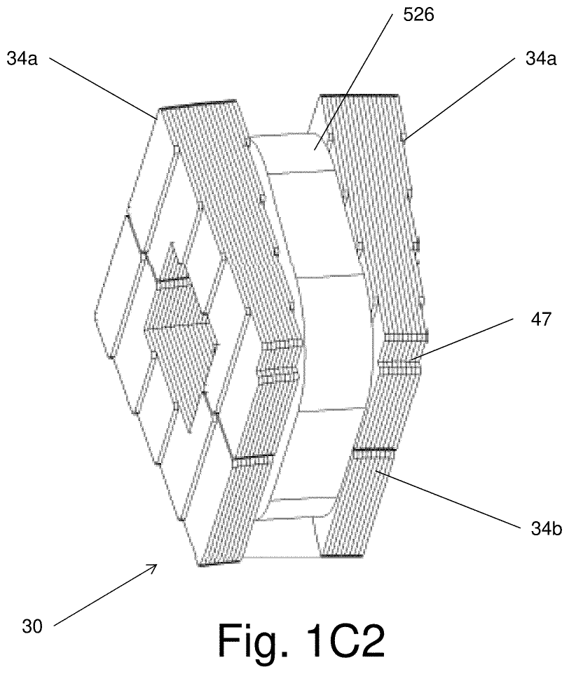

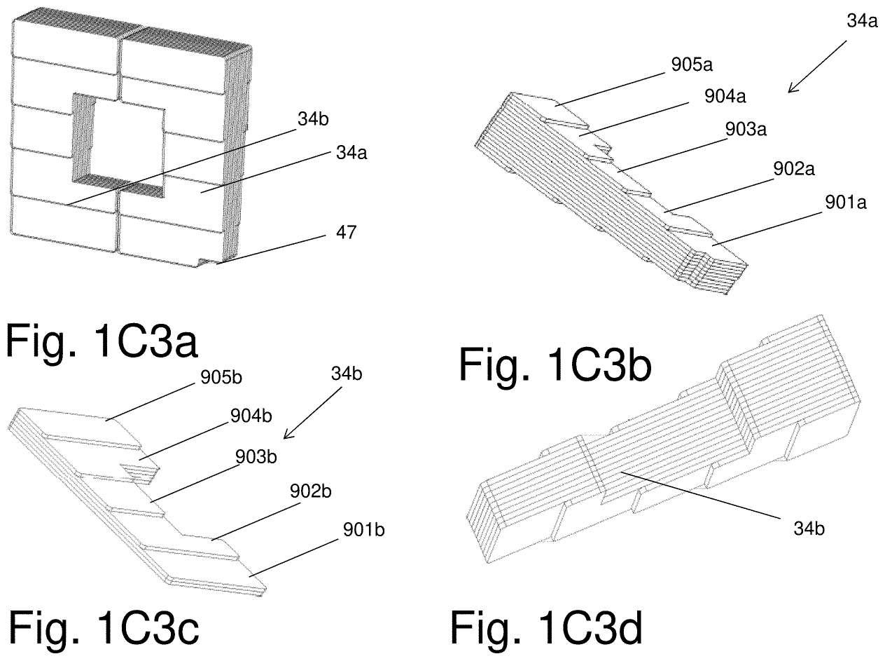

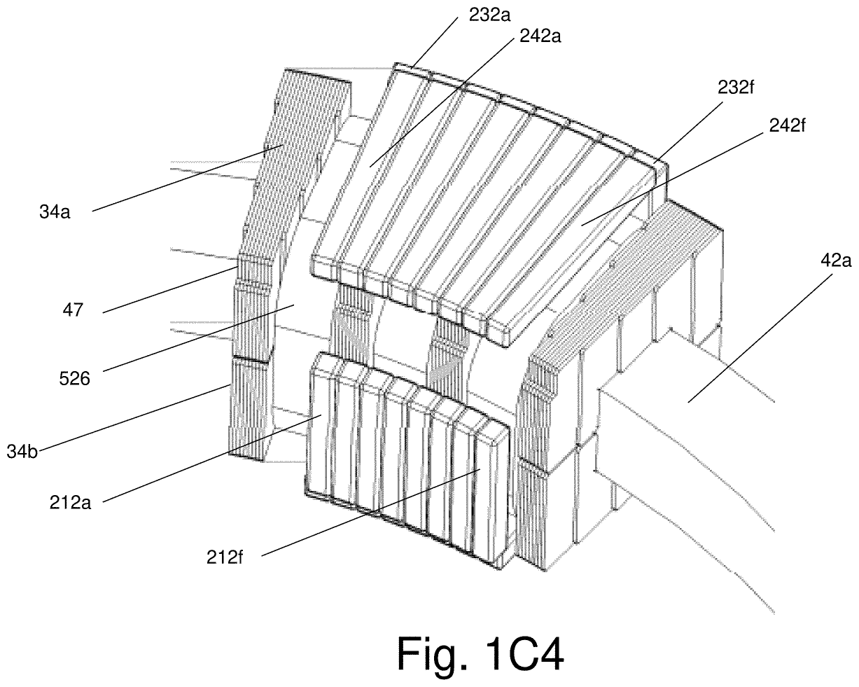

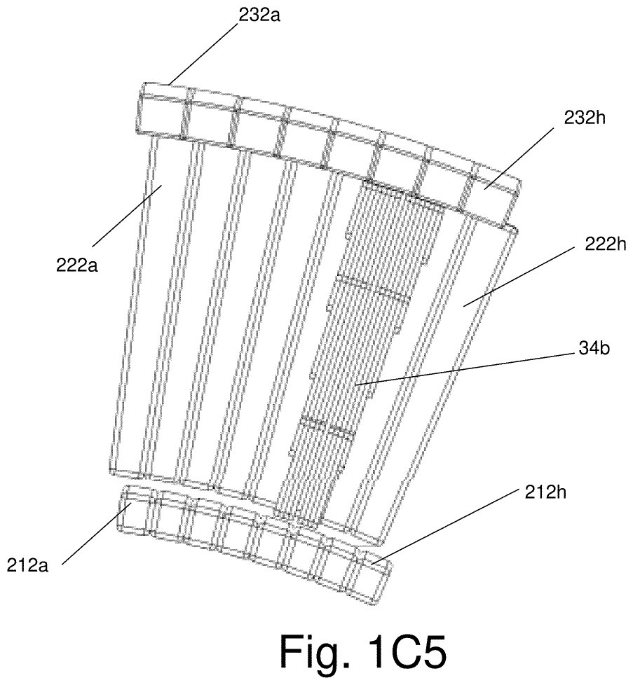

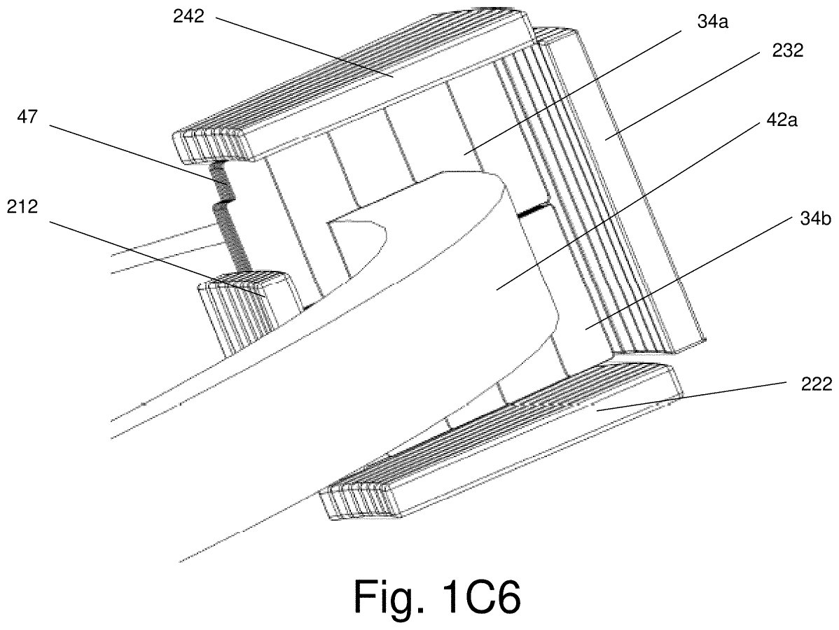

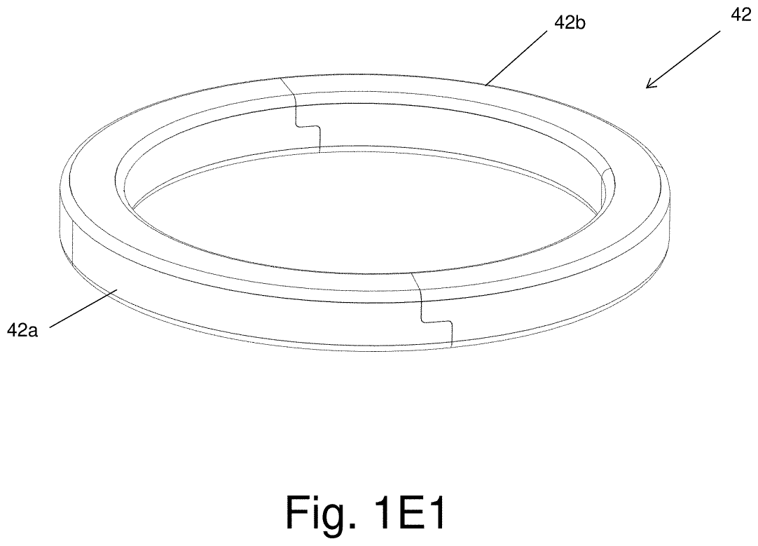

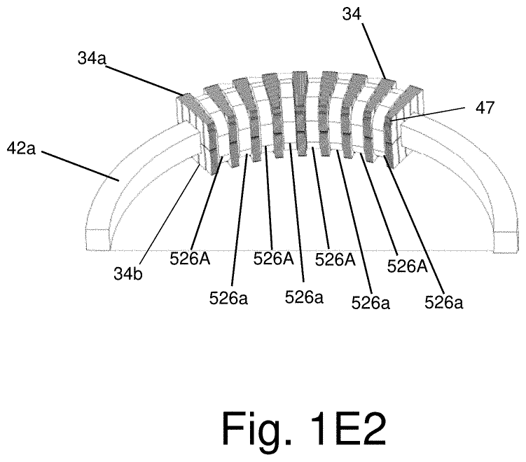

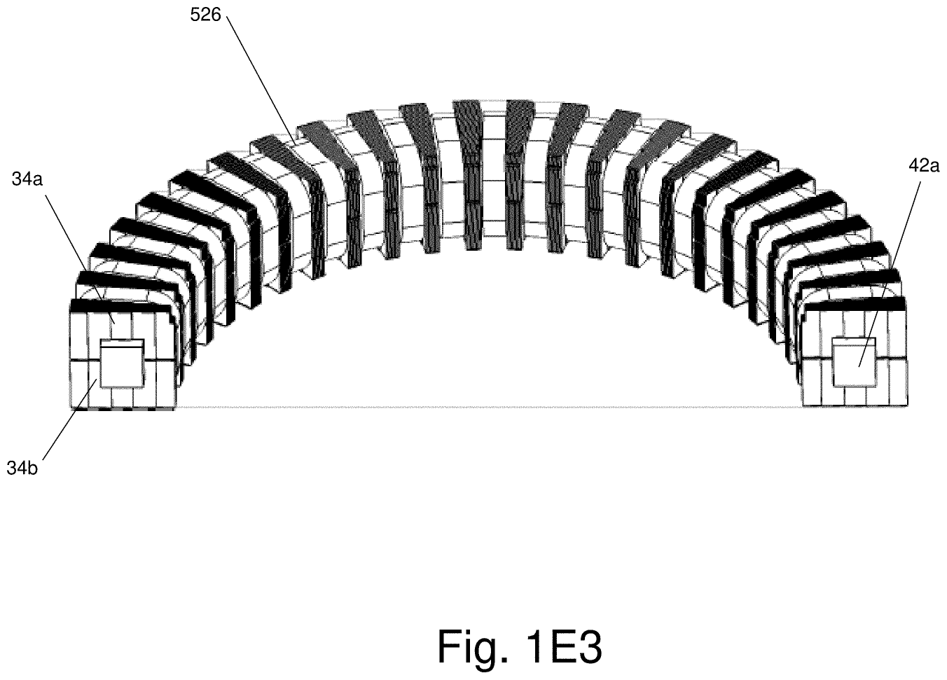

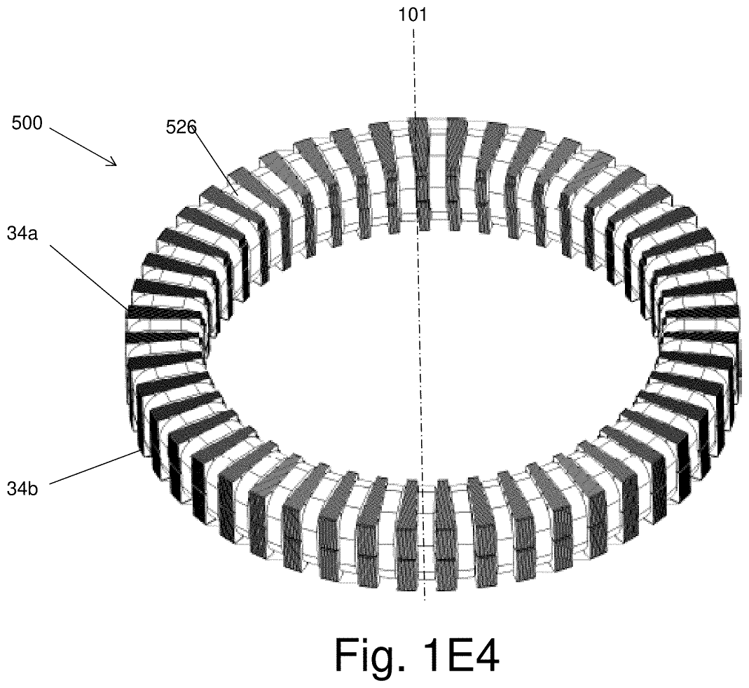

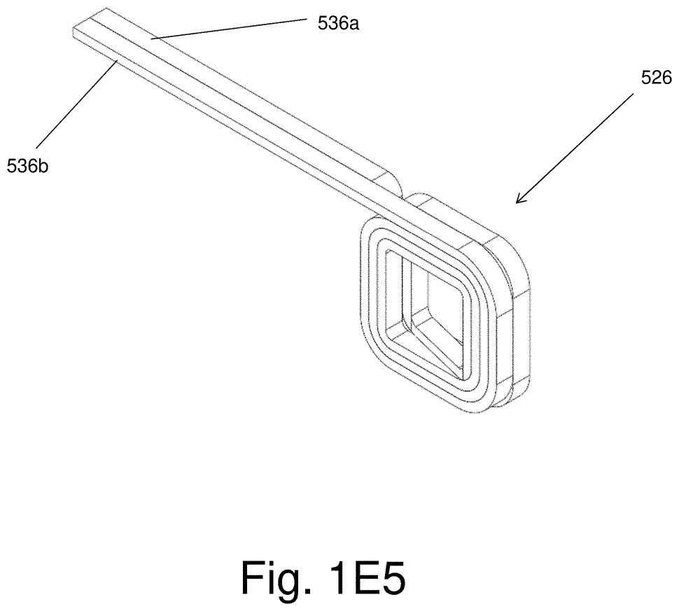

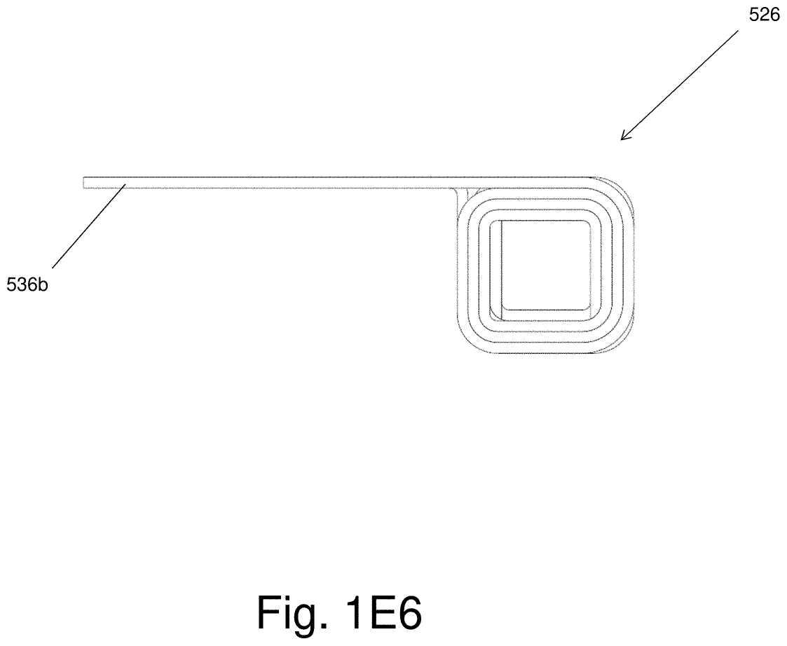

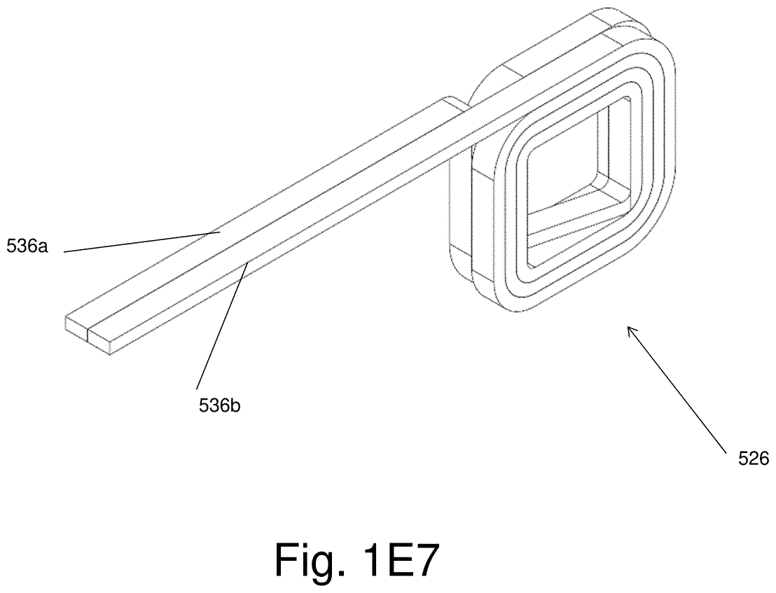

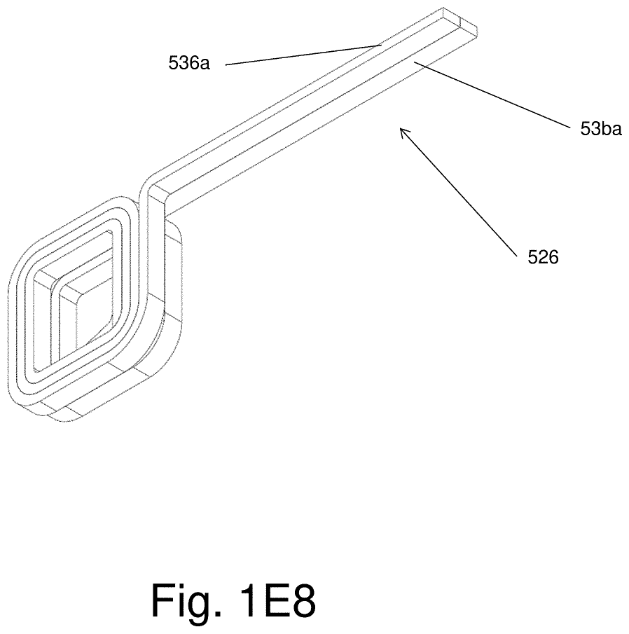

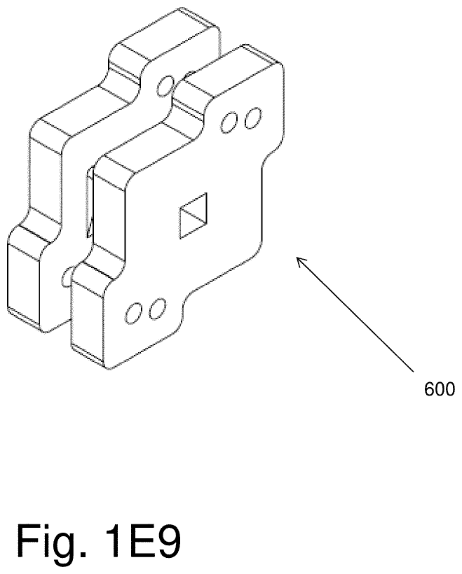

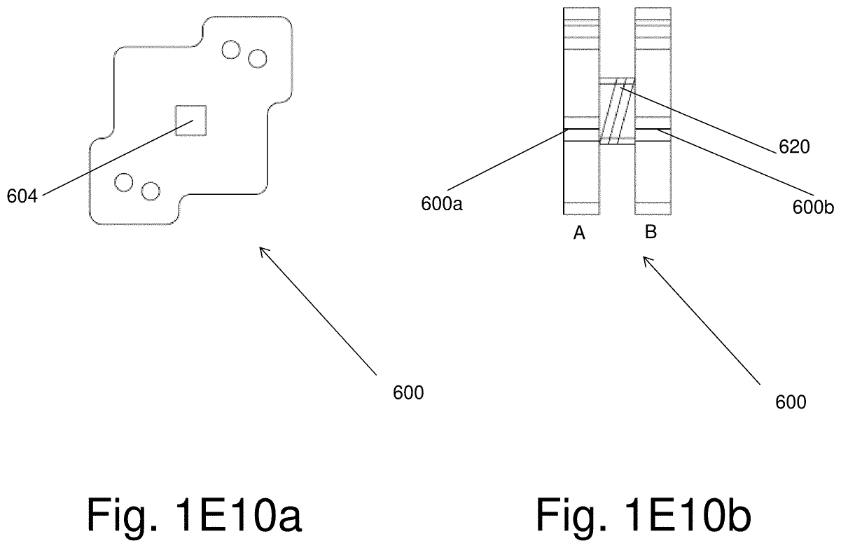

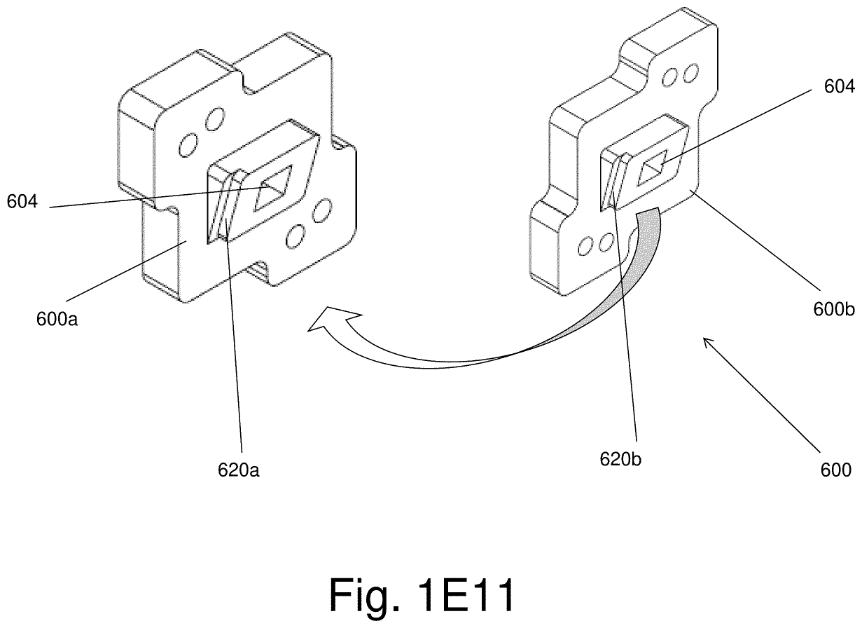

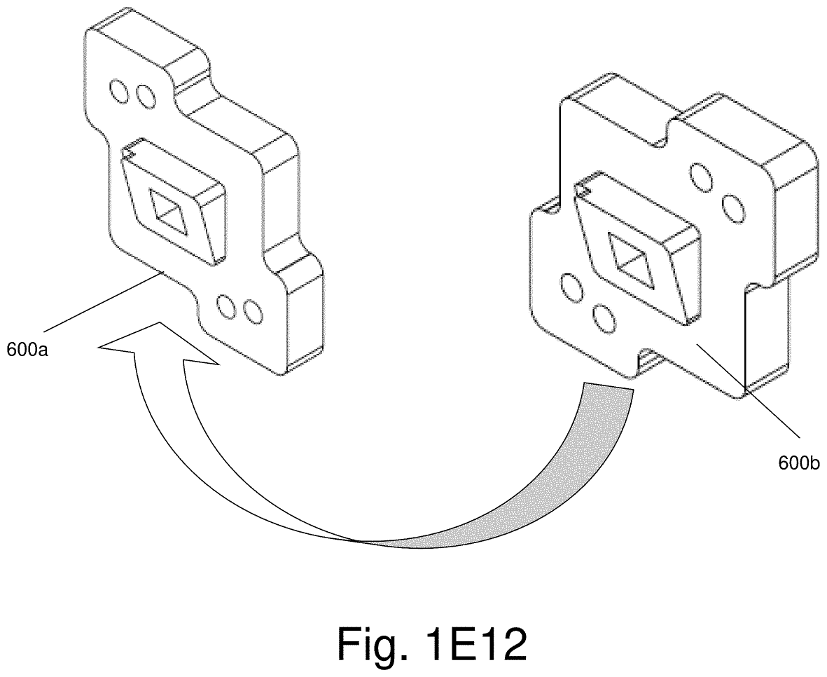

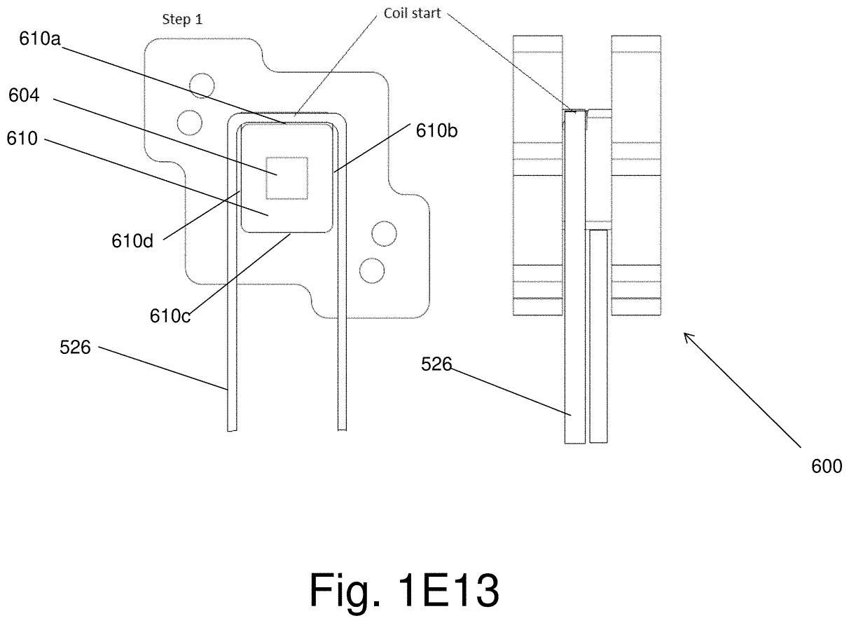

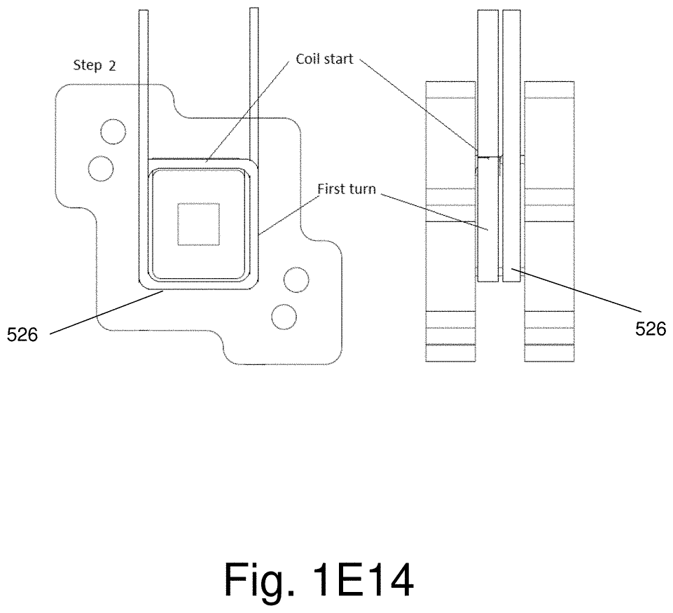

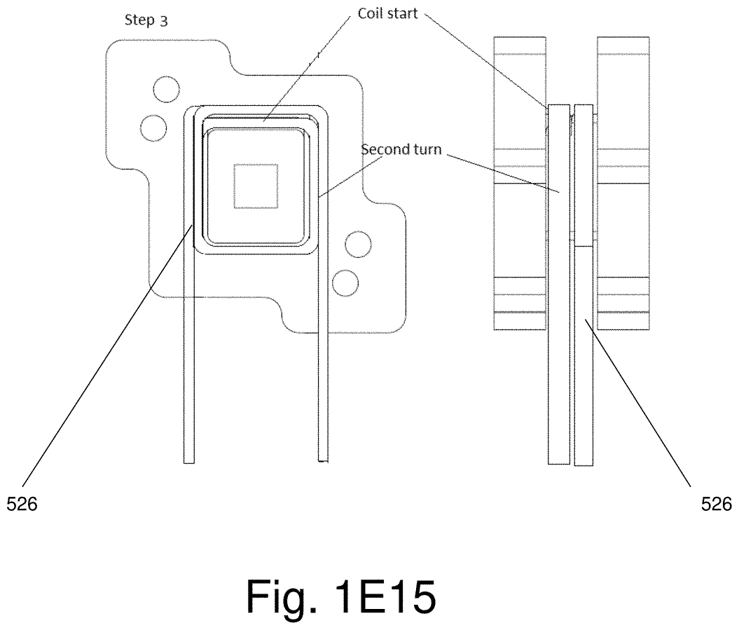

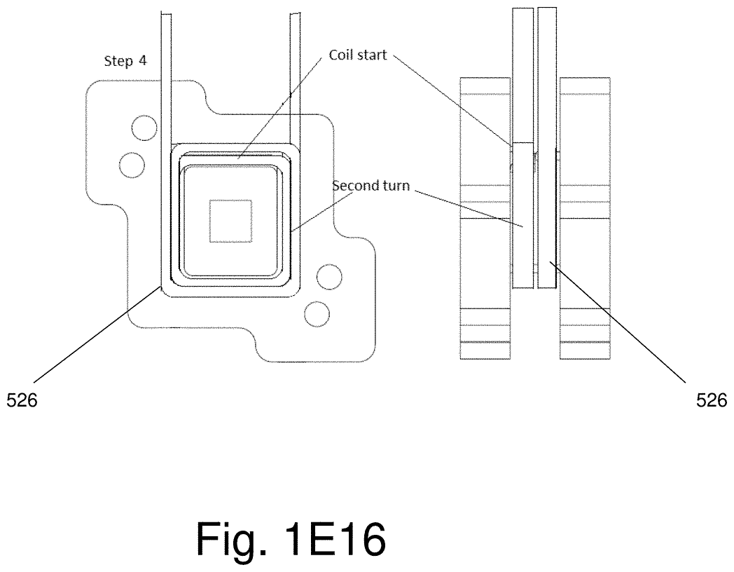

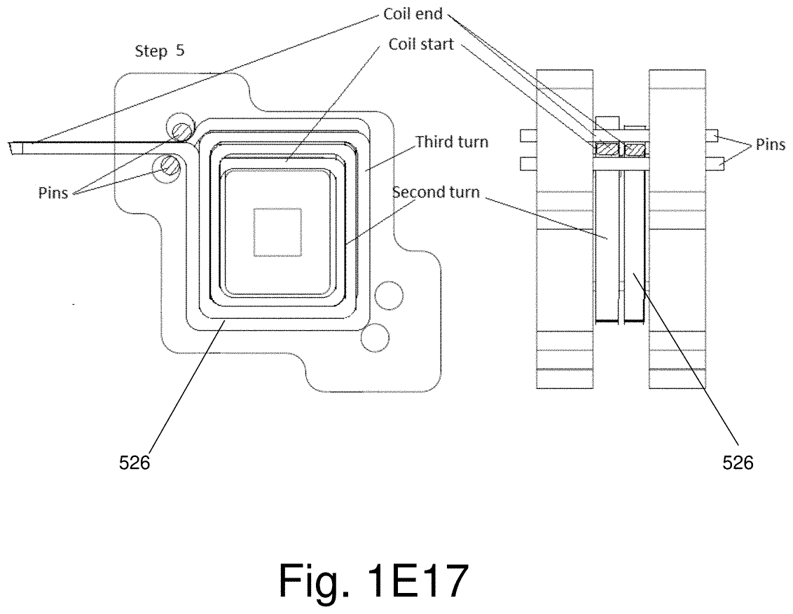

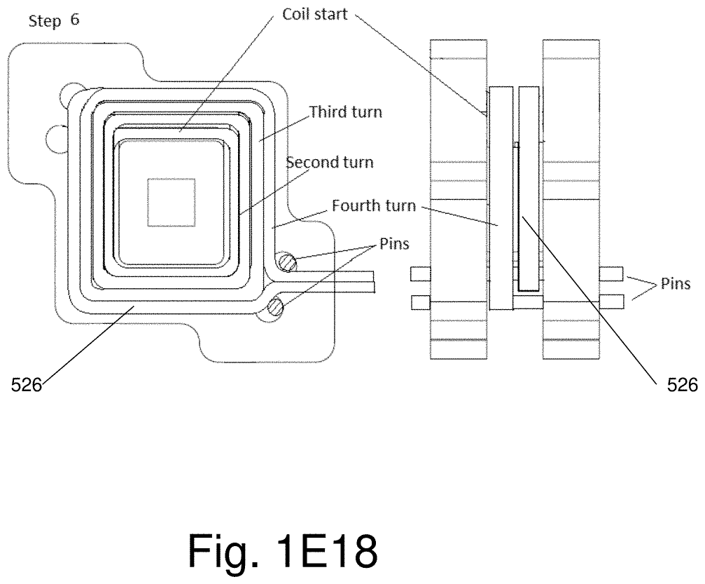

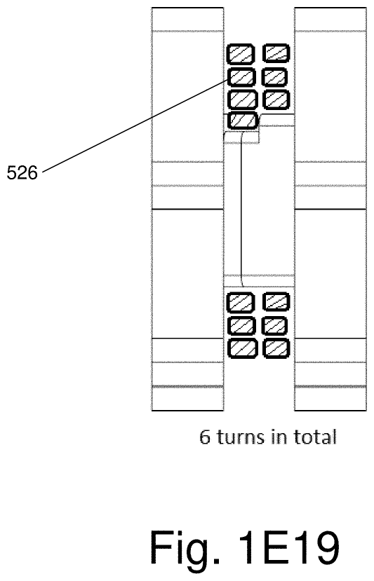

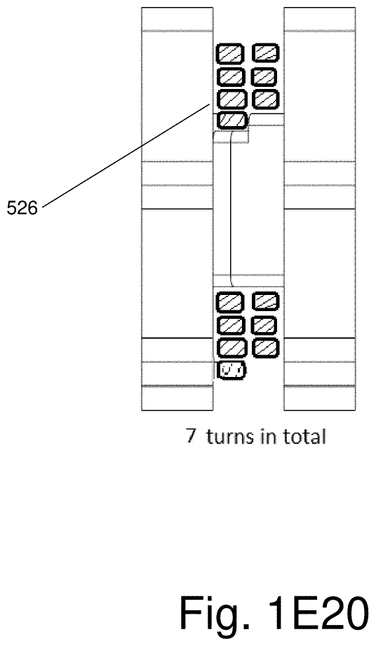

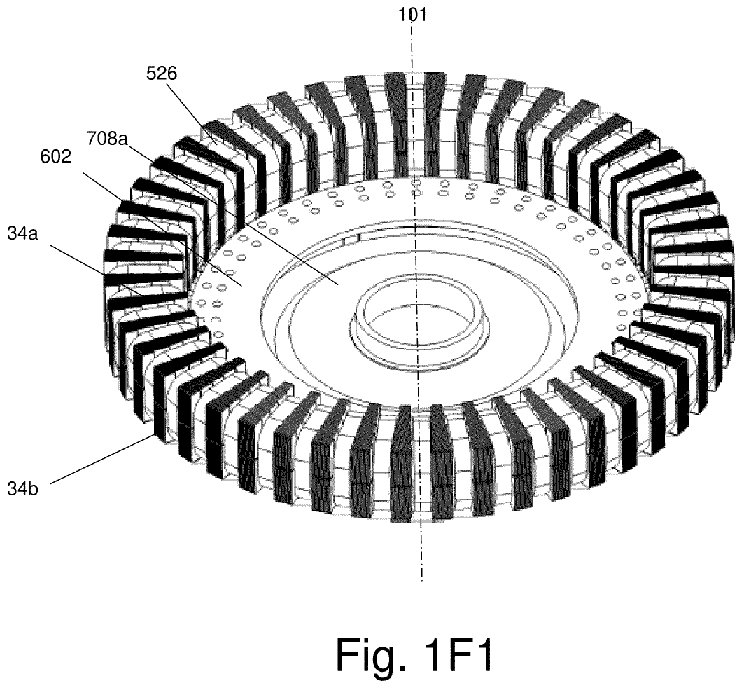

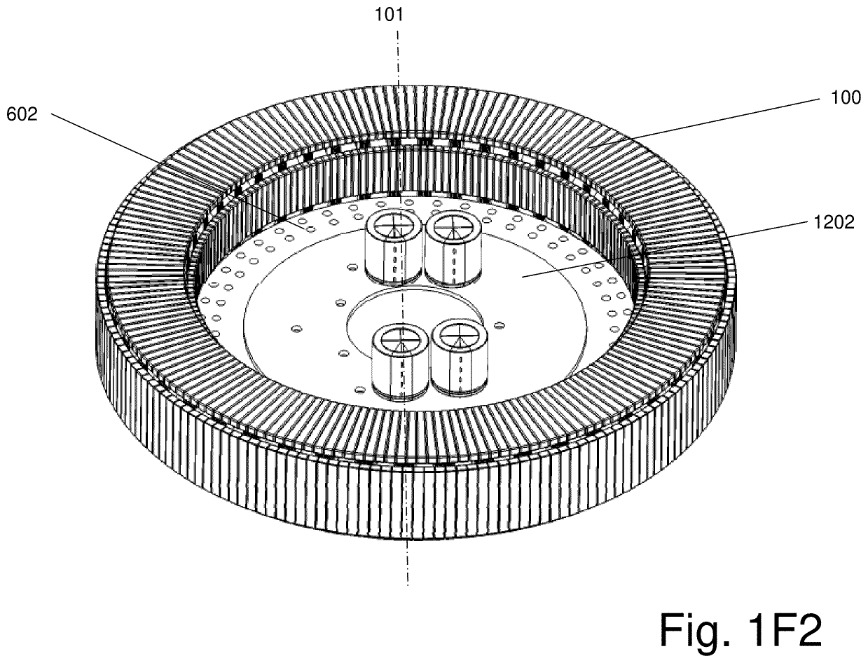

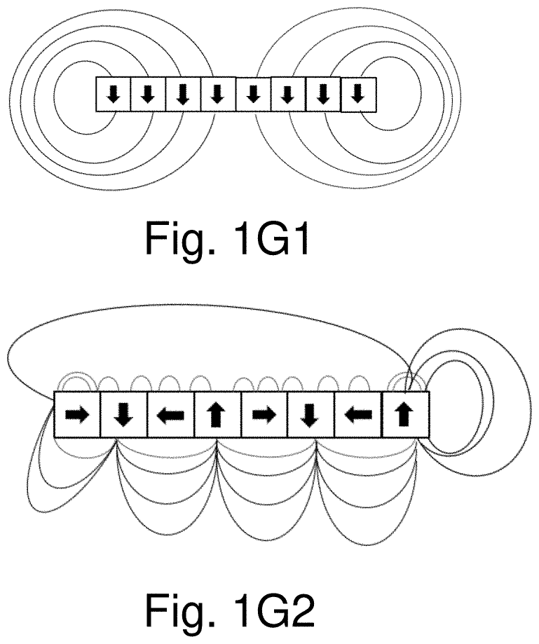

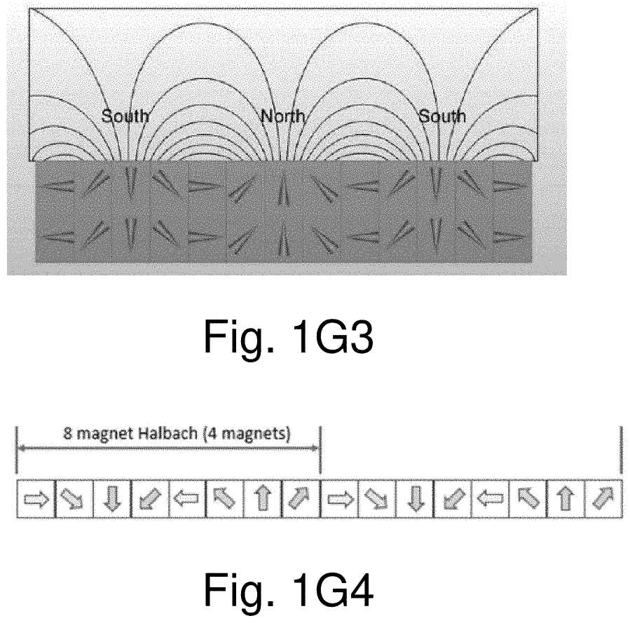

FIG. 1A1 illustrates in an exploded isometric view of several components and sub-assemblies of the electric machine 10 that is generally circular in shape and shorter axially than radially, according to embodiments, showing their relative axial positions. Moving from left to right in FIG. 1A1, are shown structural components of the electric machine: a second axial rotor core 245, a spider stator outer 708b, a spider stator inner 708a, a second sealed bearing 704b, a second retaining ring 706b, a central shaft or axle 702, an outer rotor core 235, a first retaining ring 704a, a first sealed bearing 704a, an inner rotor core 215, and a first axial rotor core 215. The electric machine 10 may also include electrical/electromagnetic components. Moving from left to right in FIG. 1A1, are also shown electrical/electromagnetic components of the electric machine: a brushless motor controller 1202, a PCB interconnect board 602, and a coil winding assembly 500 (not shown) surrounded by a quadruple-rotor assembly including a magnetic toroidal cylinder 100 having an inner rotor core 215, a first axial rotor core 225, an outer rotor core 235, and a second axial rotor core 245. These components are aligned about center axis 101 which is also the center of rotation of the electric machine 10.

In some embodiments, the second axial rotor core 245, the outer rotor core, inner rotor core 235, the first axial rotor core 225, and the inner rotor core 215 may be mechanically coupled and therefore rotate together. In certain embodiments, the inner rotor core 215 and the first axial rotor core 225 may be formed of a single casting. In one embodiment, the combined inner rotor core 215 and the first axial rotor core 225 may be mutually joined coupled to the outer rotor core 235 and the second axial rotor core 245 by means of at least one mechanically fastener 238. In other embodiments, some of these elements, and other elements, may be configured for independent rotation about the center shaft 702 and/or center axis 101.

In certain embodiments, one or more of the rotor cores, 215, 225, 235, and 245 may form part of a back-iron circuit 804 of the electric machine 10. The back-iron circuit 804, while theoretically optional, serves to strengthen magnetic elements as described below and constrain the magnetic circuit to limit reluctance by removing or reducing the return air path. Embodiments, of the electric machine 10 are also known as the Hunstable Electric Turbine (HET) or a circumferential flux four rotor electric machine.

In some embodiments, the back-iron circuit 804 may be electric steel (magnet steel) that also provides structural integrity due to its high rigidity/stiffness. In other embodiments where the magnetic toroidal cylinder 100 comprises a plurality of Halbach Arrays such heavy materials may not be needed for the rotor cores 215, 225, 235, and/or 245, although a stiff structure may be required for structural integrity—such as Polyether Ether Ketone (PEEK), aluminum, carbon fiber or the like.

In the embodiment of FIG. 1A1, the spider stator outer 708b, the spider stator inner 708a, the brushless motor controller 1202, the PCB interconnect board 602, and the coil winding assembly 500 are mechanically coupled together to form a stator assembly 105 that is fixed in place and the magnetic toroidal cylinder 100 is part of the rotor assembly. Structural components, such as the bearings 704a and 704a, retaining rings 706a and 706b, spider stator inner 708a, and spider stator outer 708b, position and secure the rotor assembly about the center shaft 702.

In other embodiments, the coil winding assembly 500 may be configured to rotate about the enter axis 101 with each of the coil winding phases of the coil winding assembly 500 being electrically coupled via a conventional rotary slip ring(s) interface. In such an embodiment, the inner rotor core 215, first axial rotor core 225, the outer rotor core 235, and the second axial rotor core 245 may function as the stator of the electric machine 10.

In the illustrative embodiment of FIG. 1A1 the coil winding assembly 500 is supported, at least in part, by the spider stator outer 708b extending from the coil winding assembly 500 through an inner slot defined by a first end of the inner rotor core 215 and an inner edge of the second axial rotor core 245. In other embodiments, when the coil winding assembly 500 is functioning as a rotor, the coil winding assembly 500 may be supported by a support ring extending from the coil winding assembly 500 through an inner slot within the inner rotor core 215 to the center shaft 702. However, the illustrated embodiment is only one way of configuring the rotors of the electric machine 10 and supporting the coil winding assembly 500 of the stator.

FIG. 1A2 illustrates the second axial rotor core 245, which may have a central circular opening 247 large enough in diameter to accept a tapered second end 702b of the central shaft 702 (not shown for clarity). FIG. 1A2 also illustrates the spider stator outer 708b which may be mechanically coupled to the spider stator inner 708a and adjacent to the second sealed bearing 704b.

FIG. 1A4 illustrates the first axial rotor core 225, which may have a central circular opening 227 large enough in diameter to accept the first sealed bearing 704a. The first sealed bearing 704a may have a central opening 704c large enough in diameter to accept a first end 702g of the center shaft 702. The first axial rotor core 225 may also have an outer edge 226 defining one or more apertures 228 for a fastener (not shown). The first axial core 225 may further include a plurality of structural ridges 229 within an inner cavity that are configured to provide mechanical strength while reducing the overall weigh of the electric machine 10. In certain embodiments, the inner cavity may be defined, at least in part, by the inner rotor core 215. As shown in FIG. 1A4 the first retaining ring 706a may be used to position and retain the first sealed bearing 704a with respect to the first axial rotor core 225 and the first end 702g of the center shaft 702.

Magnetic Toroidal Cylinder

FIG. 1B1 is a detailed isometric view of one embodiment of the assembled magnetic toroidal cylinder 100 or magnetic disk of FIG. 1A1. In the embodiment illustrated in FIG. 1B1, the magnetic toroidal cylinder 100 is centered about a longitudinal axis 101. In certain embodiments, the magnetic toroidal cylinder 100 may include a first axial magnetic wall 222 (not shown, also called a side wall or axial wall) and a second or opposing axial magnetic wall 242 positioned a predetermined distance from the first axial magnetic wall 222 along the longitudinal axis 101. An outer radial magnetic wall 232 and an inner radial magnetic wall 212 are generally longitudinally positioned between the first axial magnetic wall 222 and the second axial magnetic wall 242. Each of the magnetic walls 212, 222, 232, and 242 comprising a plurality of permanent magnets position about with uniform angular spacing and coupled to their respective rotor cores (not shown) of their corresponding rotor assemblies.

In certain embodiments, the axial magnetic walls 222, 242 and radial magnetic walls 212, 232 may be made of out permanent magnetic material, such as: Neodymium, Alnico alloys, ceramic permanent magnets, ferrite magnets Halbach Arrays, or the like. In one embodiment, the axial magnetic walls 222, 242, and/or radial magnetic walls 212, 232 may be electromagnets or a combination of electromagnets and permanent magnets.

In some embodiments, each of the plurality of permanent magnets need not be perfectly rectangular, although a substantially rectangular shape may be preferred in some applications.

FIG. 1B2 is an isometric view illustrating the outer stator spider 708b coupled to and supporting the upper stator poles 34a of the coil winding assembly 500 by way of the slot 212 defined in the magnetic toroidal cylinder 100.

FIG. 1B3 is an exploded isometric view illustrating the outer stator spider 708b coupled to the upper stator poles 34a of the coil winding assembly 500. In certain embodiments, the outer spider stator 708b may assist with placement and alignment of the stator pole upper 34a and stator pole lower 34b on a center ring-like core or yoke 42 within a central interior space or cavity of the coil winding assembly 500 as illustrated.

FIG. 1C1 is an isometric view of one embodiment of a magnetic tunnel segment 150 which defines an interior space, cavity or “magnetic tunnel” 158. For instance, the magnetic tunnel segment 150 illustrated in FIG. 1C1 may be a portion of the magnetic toroidal cylinder 100 illustrated in FIG. 1B1. Arrow 122 illustrates a circumferential direction with respect to the longitudinal axis 101 and arrow 124 illustrates a radial direction with respect to the longitudinal axis 101. Arrow 122 also indicates a relative circular path of motion of the rotor(s) of the electric machine 10.

For the particular magnetic tunnel segment 150, the north magnetic pole(s) of the magnet(s) forming the outer radial magnet wall 232 are orientated in a radial direction, such that they face inward towards the interior space or magnetic tunnel segment 158. Similarly, the north magnetic pole(s) of the magnet(s) forming the inner radial magnet wall 212 are orientated in a radial direction such that they also face inward towards the interior space or tunnel 158. Thus, both the outer radial magnet wall 232 and the inner radial magnet wall 212 have their magnetic poles generally orientated in the radial direction with respect to the longitudinal axis 101 as indicated by the arrow 124 of FIG. 1C1. In contrast, the magnetic poles of the magnets forming the first axial magnet wall 222 and the second axial magnet wall 242 have their magnetic poles orientated generally parallel to the longitudinal axis 101.

Thus, in the illustrative embodiment of FIG. 1B1 and FIG. 1C1, the individual magnets in the magnet walls 212, 222, 232, and 242 all have their “like magnetic poles” orientated towards the interior space 158 or away from an interior space 158. The term “like magnetic poles” used in this disclosure refers to a group of magnetic poles of either all north poles or all south poles. For instance, the magnetic pole orientation or configuration within region a-d of FIG. 1C1 may generally be called a “SSSS” magnetic pole configuration, because all of the magnets forming the magnet walls 212c, 222c, 232c, and 242c have their south poles facing inward. Further, the magnetic pole configuration within region e-h of FIG. 1C1 may generally be called a “NNNN” magnetic pole configuration, because all of the magnets forming the magnet walls 212f, 222f, 232f, and 242f have their north poles facing inward, as illustrated in more detail in the Halbach Array embodiments of FIG. 1G3 and FIG. 1G4, which also comprise Halbach Arrays having eight permanent magnets with a spatially rotating pattern of magnetization. This arrangement of magnets directs flux from four or more directions into the coils 526 of the coil winding assembly 500. That is, the two Halbach Arrays with poles facing radially direct magnetic flux radially and the two additional Halbach arrays with poles facing axially direct magnetic flux axially into coils 526 of the coil winding assembly 500. Thus, the magnets of the various Halbach Arrays may be adjacent to different sides of the coils 526. Further, the coils 526 in the coil winding assembly 500 may be oriented so that current flowing in the winding flows in a plan that is perpendicular to the direction of rotation of the rotor of the electric machine 10 and the center core 42.

Transverse brushless flux electric machines (TFM) conduct magnetic flux perpendicular (transverse) to the current in the coil and can produce higher torque density than longitudinal brushless flux electric machines. TFM have high power density and can be configured as electric motors or electric machines. By placing the coil 526 winding around the center core 42 of the stator the axial length of the TFM may be reduced, this and the disclosed novel arrangement of magnetic rotors makes the topology useful for in-wheel motor applications. High torque density direct-drive electric machines are highly suitable as electric vehicle motors, at least because they have high torque at low speed while also providing higher reliability and lower cost by eliminating the lost of efficiency associated with a mechanical gearbox.

In certain embodiments, the permanent magnets of the Halbach Arrays, or electromagnets, or combination of the two may be mounted on independent rotors that may be rotated independently for the purpose of field weakening or the like.

In some embodiments, the magnetic walls 212, 222, 232, and 242 of the THEM 200 may further define a transverse slot 550 around the Halbach Array coil winding assembly 500 to provide access for the support frame or spider stator inner 708a. In the illustrative embodiment of FIG. 1B1 the transverse slot 550 is defined by an inner edge of the second axial magnet wall 242 of the second axial rotor assembly 240 and the first end of the inner radial magnetic wall 212 of the inner rotor assembly 210.

In certain embodiments, the slot 550 may be wide enough to enable the passage of a support structure, electrical wires and/or conduits, or cooling conduits, but narrow enough to keep the flux forces associated with the magnetic tunnel segment 150 from exiting through the slot 550.

Coil Winding Assembly:

When the electric machine 10 is assembled, a coil winding assembly 500 is concentrically positioned between the outer radial magnetic wall 232 and the inner radial magnet wall 212, and also longitudinally positioned between the first axial magnet wall 222 and the second axial magnet wall 242 forming the magnetic toroidal cylinder 100.

The coil 526 may be made from a conductive material wire, such as copper or a similar alloy. In one embodiment, concentrated windings may be used.

In certain embodiments, each of the coils 526 may surround and be wound around a bobbin (not shown), which may be sized to be positioned onto the center ring-like core 42. The individual coils 526 may be essentially cylindrical, square, or rectangular in cross-sectional shape. The bobbin may be made from a Polyether ether ketone (PEEK), which is a colorless organic thermoplastic polymer material or a glass-reinforced thermoplastic. In another embodiment, each of the coils 526 may be coupled to a PCB module (not shown). In certain embodiments, the coil winding assembly 500 may be formed of coil modules 30 comprising a coil 526 and in some instances, a bobbin and/or PCB module, positioned adjacent to and between a pair stator poles 34, which are collectively positioned about the central core or yoke 42 (see FIG. 1C2)

The windings of each coil 526 are configured such that they are generally perpendicular to the direction of the relative movement of the magnets or rotor. In other words, the coil windings 526 are positioned such that their longitudinal sides are parallel with the longitudinal axis 101 and their ends or axial sides are radially perpendicular to the longitudinal axis 101. Thus, the coil windings 526 are also transverse with respect to the magnetic flux produced by the individual magnets of the rotor at their interior face. Consequently, essentially the entire coil winding 526 or windings may be used to generate motion in motor mode or voltage in generator mode.

In certain embodiments, a PCB module (not shown) may be positioned radially adjacent to the inside face of the coil 526 and is electrically coupled to the coil 526. In some embodiments, the PCB module may be configured to route the leads of the coil 526 to the center or exterior of the stator. In certain embodiments, the PCB module may include one or more sensors, including, current sensors, rotor(s) position sensors, thermal sensors and Hall Effect sensors (not shown) that relay operational parameters of the coil winding assembly during operation or prior to operation by an embedded wireless antenna. In some embodiments, one or more of the thermal sensors may be a thermocouple. In yet other embodiments, there may be antennas and transceivers for wireless power transfer and/or communication transfer. In certain embodiments, there may be PCB connectors that allow the coils 526 to plug directly into a brushless motor controller 1202 (not shown) or a PCB interconnect PCB 602 (not shown).

FIG. 1C2 is an isometric view of a coil 526 situated between a pair of stator poles 34. In certain embodiments, each of the stator poles 34 may comprise an upper stator pole 34a portion and a lower stator pole 34b portion. As illustrated, each of the upper stator pole portions 34a may include a receiving slot 47 sized to receive a corresponding engagement notch 605 on a radial arm 610 of the outer stator spider 708b.

In some embodiments, the coil 526 may be sandwiched between the two poles 34 to form a coil module 30 for phasing purposes. In yet other embodiments, a “coil” for phasing purposes may actually be two physical coils 526 (and its associated bobbin and PCB module) separated by poles 34. Positioning the coils 526 within the pole portions 34a and 34b reduces the air gap between the coils 526. By reducing the air gap, the coil winding assembly 500 can contribute more flux linkage to the overall torque produced by the motor. In certain embodiments, the first pole portion 34a and second pole portion 34b may operate together as a single pole for phasing purposes. In another embodiment, the pole portions 34a, 34b may be shaped on their leading edges so as to draw warm fluid from within an interior volume of the coil winding assembly 500.

When the coil winding assembly 500 is energized, the current running through the coil windings 526 positioned within the portion of the magnetic tunnel segments 150 having a “NNNN” magnetic pole configuration may flow in an opposite direction than the current running through the coil windings positioned in the portion of the magnetic tunnel segment 150 having a “SSSS” magnetic pole configuration so that the direction of the generated magnetic force or torque is the same throughout the entire magnetic toroidal cylinder 100.

In certain embodiments, the stator pole 34 is a flux concentrator and is formed such that one side of the coil 526 partially fits within an indent formed within the side of the respective pole portion (not shown). In certain embodiments, the pole portion 34 may be a solid material structure, which is sintered cast or 3D printed, solid block material, back iron material, and/or heatsink material. In some embodiments, the pole portion 34 may be made from aluminum and may be used as a heat sink to draw heat to either the back-iron circuit described below or another cooling mechanism or heat sink.

In certain embodiments, the stator pole portions 34a and 34b may be formed of a “soft magnetic” material. In another embodiment, an isolation spacer or heat sink (not shown) may be positioned adjacent to stator pole 34. In one embodiment, the spacer may be made from a lightweight non-magnetic filler material, such as aluminum, TPG, carbon fiber, or plastic. In other embodiments, potting material may be used as a spacer. As described above, the magnets of the magnetic toroidal cylinder 100 focus the flux inwardly, but the stator poles 34 and spacers can further direct the flux flow path as desired.

FIG. 1C3a through FIG. 1C3d illustrate various structure elements of a stator pole 34 having an upper stator pole portion 34a and a lower stator pole portion 34b.

FIG. 1C4 is an isometric view of the single Halbach Array Torque Tunnel segment 150 of the magnetic toroidal cylinder 100 of FIG. 1C1 and associated stator poles 34 and coils 526 of the coil winding assembly 500 positioned about the center core portion 34a.

FIG. 106 is a section view of the single Halbach Array Torque Tunnel segment 150 of the magnetic toroidal cylinder 100 of FIG. 1C1 and a single stator pole 34. As illustrated the cross-sectional shape of the stator pole 34 may be substantially trapezoidal being formed of in a staggered stacked arrangement of insulated magnetic steel laminations. This shape promotes even flux distribution at the pole faces of the stator pole 34 and within the center core portion 42a.

FIG. 1C6 is an isometric view of a portion of the magnetic flux circuit of the electric machine 10 comprising the single Halbach Array Torque Tunnel segment 150 of the magnetic toroidal cylinder of FIG. 1C1, a single stator pole 34, and the center core portion 42a.

The Central Core or Yoke and Stator Poles

FIG. 1E1 is an isometric view of a first embodiment of a center ring-like core or yoke 42 for the coil winding assembly 500. The central core 42 distributes magnetic flux to each of the stator poles 34 in the plurality of stator poles. In certain embodiments, the central core 42 may be made of at least two central core segments 42a and 42b. The central core 42 may be made out of back iron material so that the center core 42 will act as a magnetic flux force concentrator and distributes magnetic flux to each of the stator poles, or stator portions 34a and 34b.

In some embodiments, each of the two central core segments 34a and 34b may be made of pre-formed laminations covered in a thin layer of epoxy adhesive or “structural adhesive” such as acrylic, cyanoacrylate, polyurethane, or the like. In certain embodiments, the stacked and epoxy coated preformed laminations may be thermally cured. This forces the magnetic flux to stay in within each magnetic steel lamination and to flow only in the plane of the laminations.

In certain embodiments, the central core 42 may be made from tape wound magnetic steel laminations using high-speed tape winding techniques. 'The tape may have an insulated coating which then separates each magnetic steel lamination so that the magnetic flux cannot migrate from one lamination to the next. In other embodiments, the tape may be coated with an insulating layer of an electrically insulating polyimide sheet, an aromatic nylon sheet, a synthetic fiber sheet, or other non-surface core plating electrically insulating sheet to further reduce the flux and current flow. This forces the magnetic flux to stay in within each magnetic steel lamination and to flow only in the plane of the magnetic steel tape.

In certain embodiments, a cross-sectional shape of the central core 42 may be configured to promote even flux distribution to the stator poles 34a and 34b. For instance, the cross-sectional shape of the central core 42 may be square, rectangular, trapezoidal, circular, or any other shape that promotes even flux distribution to the desired areas of the stator poles 34a and 34b. In some embodiments, the central core 42 may be hollow or have passages defined therein to allow for liquid or air cooling.

The stator pole portions 34a and 34b may be modular and sized to slide over either of the central core segments 42a and 42b when coupled together. FIG. 1E2 is an isometric view of the coils 526, and the stator poles 34, associated with one half of a single phase of a 3-phase coil winding assembly 500 positioned on a representative one third portion of the center core segment 42a. FIG. 1E3 is an isometric view of the central core segment 42a illustrating coils 526 and stator poles 34 positioned over the entirety of the central core segment 42a. Any number of coil modules 30 may be coupled depending on the particular application. In some embodiments, the coils 526 may essentially form one continuous coil 526, similar to a Gramme Ring. FIG. 1E4 is an isometric view of a complete coil winding assembly 500 formed by joining the center core portion illustrated in FIG. 1E3 with another core portion also having a full complement of coil 526 and stator poles 34. The ring-shaped winding of the coils 526 couples each stator pole 34 to the entire armature ampere-turns of each coil 526.

Bobbin Fly Wound Coil Method for Thick Wire Gauges

An improved method of bobbin fly winding toroidal coils is proposed for electric machines requiring high torque and high efficiency in which heavy or thick wire gauges are used for the coils of the coil winding assembly.

In general, current flowing through copper wire coil windings wrapped around an iron core (stator) creates an electro-magnetic field that either opposes or attracts the magnetic field produced by permanent magnets coupled to a rotor or drive shaft. The interaction of the electromagnetic field with the field of the permanent magnets produces torque. The torque of the electric machine is based on, at least in part, the voltage applied to the copper wire, the density of the wire, the number of coils, and the number of coil windings. The electric machine's (motor's) maximum speed is determined, at least in part, by the amount of current flowing through the coils.

As the name suggest, a stator does not move, but provides the force that drives the rotor(s). The stator is generally laminated to minimize eddy current losses in the form of heat and is divided into slots. During the manufacturing process insulated coils of copper wire are inserted into the slots and arranged so that current flowing through them creates an electro-magnetic field. The size and number of slots determine, at least in part, how much wire can be contained in each coil, and the diameter/area of the wire determines, at least in part, how much current can pass through each coil. Because stators are cylindrical, the slots are wedge like in shape. One of the challenges facing an electric machine manufacture is how to maximize the amount of copper wire inserted into each of the slots, commonly referred to as “slot fill factor”, in order to maximize the torque output without adversely affecting the manufacturability of the stator. While a 100% slot fill factor would theoretically result in the maximum possible output torque for an electric machine, in practice an electric machine having a 100% slot fill factor is impossible to build because insulation on the wire reduces the amount of cross-sectional area that is conductive material, and round wire, commonly used in coil windings, leaves gaps between windings of round wires no matter how efficiently arranged. The effective slot fill factor is further reduced because some of the available space may be used by insulating slot liners, wedges, phase separators (where two phases share the same slot), and the like. In a conventional electric machine copper generally accounts for about 60-70% of the total slot fill, because fill factors higher than this greatly increases the manufacturing complexity and the potential for quality issues. For instance, obtaining a higher slot fill factor, greater than about 80%, without damaging either the wire or its insulation can be difficult without slowing down the winding process and/or specialized tools and fixtures. Other parameters that affect the manufacturability of the required slot fill factor are the stack aspect ratio, the design of the slot opening (size and shape), the coil bundle size, the wire gauge, and the like. Beyond slot design, coil winding and insertion techniques can affect manufacturability and slot fill.

In certain embodiments, the coil winding process may include a double-back coil configuration. A double-back coil uses half as many turns and the same number of wires in parallel but twice as many coils, which increases the overall length of the wound coil set. This winding process comprises inserting two coils back to back for each slot, which breaks down each coil into a more manageable half size coil, while still inserting the same amount of wire per slot.

In certain embodiments, the coil winding process may comprise a 2-coils-make-1 coil method. In the 2-coils-make-1 method each coil has half as many turns and wires in parallel but twice the total number of coil sets. One coil from each coil set is inserted at the same time. Once inserted the coil sets are then connected in parallel to achieve the same number of wires in parallel. This is similar to the double-back winding process in that the coil bundle is half the size, but 2-coils-make-1 does not double the overall length of the coil.

Coils with random winding can cross over each other and will not be consistently layered in the slots. This variation is difficult to anticipate in the design phase. One way to reduce wire crossover is to use precision wound coils that are either hand inserted or machine inserted. This can reduce wire crossover, but additional tooling/fixtures are required to place the wires precisely in the slots.

With the segmented coil winding assembly 500, the stator can be broken up into multiple individual segments based on the number of teeth in the design. These individual segments are then wound as a concentrated pole where the wire is either wound separately and installed to the tooth or the wire is wound directly onto the tooth without any interference from neighboring teeth. Once the teeth are wound, they can then be assembled together to form the compete coil winding assembly 500. This method can allow for higher slot fill since the tooling is all external to the stator and you do not need to have the wire pass through a slot. The difficulty with this type of assembly is the design of how the teeth coupled together and are restrained to ensure that electromagnetic path is closed.

This invention describes a winding process for fly winding toroidal coils for the coil winding assembly 500 and similar or analogous stators comprising multiple individual segments that are coupled together to form a complete stator assembly.

In certain embodiments of the bobbin fly winding process both ends of the coil 526 may be wound simultaneously. In one embodiment, both ends of the coil 526 may be wound simultaneously starting from the middle of the coil 526. Coils 526 wound with this winding process are more compact and have shorter terminals, thereby providing a better slot fill factor and lower resistance, than cons wound with a conventional winding process(es), such as fly winding coils, toroidal cons, bobbin wound cons, and the like. The prior art methods of winding the coils start the coil winding from one end and finish the coil winding at the other end. This produces a space required for the beginning of the coil winding which takes space from the slot and from the magnetic path reducing the slot fill factor. The embodiments of the bobbin fly winding process where both ends of the coil 526 are wound simultaneously eliminates the beginning wire. The bobbin fly winding process may be performed manually and/or be an automated process. For instance, a robot can be built to perform all or parts of the disclosed bobbin fly winding process.

FIG. 1E5 is a top-right isometric view of a competed fly wound bobbin coil 526 wound by the bobbin fly winding process disclosed herein.

FIG. 1E6 is a side view of the competed fly wound bobbin coil of FIG. 1E5 wound by the bobbin fly winding process disclosed herein.

FIG. 1E7 is a top-left isometric view of the competed fly wound bobbin coil of FIG. 1E5 wound by the bobbin fly winding process disclosed herein.

FIG. 1E8 is a bottom-right view of the competed fly wound bobbin coil of FIG. 1E5 by the bobbin fly winding process disclosed herein.

In certain embodiments, the process of winding the heavy gauge coils 526 of the coil winding assembly 500 may include, at least in part, a fixture tool 600 that contains the coil 526 during the winding process. In one embodiment, the fixture tool 600 may include provisions/fixtures for assisting with the bending/forming of the heavy gauge wire of the coils 526 during the winding process.

FIG. 1E9 is an isometric view of a fixture tool 600 for a double fly winding bobbin coil.

FIG. 1E10a is a side view of the fixture tool 600 of FIG. 1E9 illustrating the left side (Part A) 600a of the fixture tool 600 and the right side (Part B) 600b of the fixture tool 600. In certain embodiments, the left and right sides 600a, 600b of the fixture tool 600 are paired together and fixed in a vice grip using a rectangular shaft (not shown) through a rectangular aperture(s) 604 formed in the left and right sides 600a, 600b of the fixture tool 600.

FIG. 1E10b is an end view of the fixture tool 600 of FIG. 1E9.

FIG. 1E11 are more detailed isometric views of Part A, 600a and Part B, 600b of the fixture tool 600 of FIG. 1E9.

FIG. 1E12 are alternative more detailed isometric views of Part A and Part B of the fixture tool of FIG. 1E9.

In certain embodiments of the bobbin fly winding process both ends of the coil 526 may be wound simultaneously. In one embodiment, both ends of the coil 526 may be wound simultaneously starting from the middle of the coil 526. Cons 526 wound with this winding process are more compact and have shorter terminals, thereby providing a better slot fill factor and lower resistance, than coils wound with a conventional winding process(es).

Once the two halves 600a, 600b of the fixture tool 600 have been coupled the wire can be installed on the fixture tool 600. In certain embodiments, the wire of the individual coils 526 may be essentially cylindrical, square or even rectangular in cross-sectional shape. In one embodiment the wire may be made of copper. In other embodiments the wire may be made of aluminum or similar alloy.

In certain embodiments, the wire may be pre-cut to length. For instance, the wire may be pre-cut to the length required to complete 6, 7, 8 or the desired number of turns.

Step 1 Starting the Winding Process

FIG. 1E13 are a side view and a corresponding end view of the fixture tool of FIG. 1E9 illustrating the starting step in the coil winding process. In the starting step the longitudinal center of the wire should be positioned in contact with an upper face 610a of a center projection 610 of the fixture tool 600. That is, the wire should be installed at about half the length on the fixture tool 600 as illustrated in FIG. 1E13.

In certain embodiments, the fixture tool 600 may include a beginning groove 620 as illustrated in FIG. 1E13, configured such that the wire can initially be installed in only one position at the start of the winding process. In one embodiment the beginning groove 620 may be formed by the coupling of the two halves 600a, 600b of the fixture tool 600. In another embodiment the beginning grove 620 may be inclined or at an angle with respect to the groove formed by the two halves 600a and 600b. In certain embodiments the groove formed by the two halves 600a and 600b may be about twice the width of the cross-section of the wire.

In yet another embodiment the wire may be pre-formed or pre-bent on the center projection 610 prior to the winding process.

In some embodiments, the center projection 610 may include a chamfer or a transitional edge between adjoining right-angled faces 610a, 610b, 610c, and 610d of the center projection 610. Sometimes the chamfer may be defined as a form of bevel. In certain embodiments, the angle of chamfer between two adjoining right-angled faces may be about 45°. In other embodiments the transition between adjoining right-angle faces 610a, 610b, 610c, and 610d may be about a quarter round.

Step 2 Competing the First Turn of the Winding Process

Once the wire has been bent downwards using the center projection 610 as illustrated in FIG. 1E13, the center projection 610 can then be used to bend the wire upwards as shown in the illustrative embodiment of FIG. 1E14.

FIG. 1E14 are a side view and corresponding end view of the fixture tool of FIG. 1E9 illustrating the coil winding process after the first turn of the coil winding process has been completed.

Step 3 Starting the Second Turn of the Winding Process

To start the second turn of the winding process as shown in the illustrative embodiment of FIG. 1E15 it is necessary to use the same portion of the center projection 610 to create a segment of the coil winding that is two wires thick.

Step 4 Competing the Second Turn

FIG. 1E15 are a side view and corresponding end view of the fixture tool of FIG. 1E9 illustrating the start of the second turn in the coil winding process. The same portion of the center projection 610 may be used to bend the wire upwards as shown in the illustrative embodiment of FIG. 1E16.

FIG. 1E16 are a side view and corresponding end view of the fixture tool 610 of FIG. 1E9 illustrating the coil winding process after the second turn in the coil winding process has been completed.

The final number of turns can be 3 or 4 on the first (same) portion of the center projection 610 as illustrate in FIG. 1E17 and FIG. 1E18. However, the fixture tool 610 may be designed for any number of turns.

Competing an Even Number of Turns

If the coil 526 is terminated on the same side as the beginning turn, the number of turns will be even because the winding is double. That is, the total number of turns is 2*N, where N is the number of compete turns counted from the first bend as shown in FIG. 1E17.

FIG. 1E17 are a side view and corresponding end view of the fixture tool 610 of FIG. 1E9 illustrating the coil winding process after the third turn in the coil winding process has been completed. That is FIG. 1E17 shows a total number of 6 turns.

Competing an Odd Number of Turns

In contrast, if the desired number of turns is odd one additional turn may be completed on the opposite side of the beginning turn as shown in FIG. 1E18.

FIG. 1E18 are a side view and corresponding end view of the fixture tool 610 of FIG. 1E9 illustrating the coil winding process after third turn in the coil winding process have been completed on both sides and a fourth turn has been completed on one side. In FIG. 1E18 the number of complete turns is 3*2 plus a half turn on one side of the center projection 610 and another half turn on the other side of the center projection 610 making 7 turns in total. That is, the total number of turns competed is 2*N+1 when the termination(s) is done on the opposite side to the beginning turn.

In certain embodiments two pins (not shown) may be inserted into the holes formed in the two halves 600a and 600b and the wire may be bent to form the terminations of the coils. As illustrated in FIG. 1E19 and FIG. 1E20 the coil terminations are adjected to each other using the disclosed bobbin fly winding process irrespective of whether the number of coil turn is even or odd,

Even (6) Number of Turns in Total

FIG. 1E19 is an end view of the fixture tool of the fixture tool of FIG. 1E9 illustrating the coil winding process after six turns in the coil winding process have been completed.

Odd (7) Number of Turns in Total

FIG. 1E20 is an end view of the fixture tool of the fixture tool of FIG. 1E9 illustrating the coil winding process after seven turns in the coil winding process have been completed.

In certain embodiments the end terminals 536a and 536b of each coil 526 may be connected to a bus bar (not shown). In another embodiments the end terminals 536a and 536b may be connected to a Printed Circuit Board (PCB) connector (not shown).

Referring once more to FIG. 1B3, in some embodiments, the spider stator outer 708b assists with placement and alignment of the coils 526 and stator poles 34 and is designed to fit within a central interior space of the coil winding assembly 500.

Once the spider stator inner 708a is in position, a PCB interconnect board 602 can then be coupled to the assembly of FIG. 1B2. FIG. 1F1 is an isometric view of the PCB interconnect board located within the complete coil winding assembly of FIG. 1E4. The PCB interconnect board 602 is also designed to fit within the central interior space of the coil winding assembly 500. In certain embodiments, the PCB connectors can be electrically coupled to the PCB interconnect board 602.

In order maintain the generated torque and/or power the individual coils 526 in the coil winding assembly 500 may be selectively energized or activated by way of a high-power switching system or brushless motor controller 1204 which selectively and operatively provides electrical current to the individual coils 526 in a conventional manner. In order to maintain rotation adjacent coils 526 may be powered up in turn. For instance, the brushless motor controller 1204 may cause current to flow within the individual coil 526 when the individual coil 526 is within a magnetic tunnel segment with a NNNN magnetic pole configuration. On the other hand, when the same individual coil moves into an adjacent magnetic tunnel segment with a SSSS magnetic pole configuration, the brushless motor controller 1204 causes the current within the individual coil 526 to flow in the opposite direction so that the generated magnetic force is always in same direction.

Once the PCB interconnect board 602 is in position the brushless motor controller 1204 may be coupled to the assembly of FIG. 1E5. FIG. 1F2 is an isometric view of the brushless motor controller 1204 coupled to the assembly of FIG. 1F1. The brushless motor controller 1204 is also designed to fit within the central interior space of the coil winding assembly 500.

In certain embodiments, the brushless motor controller 1204 may be electrically coupled to the PCB interconnect board 602 to form a power module assembly 606. In one embodiment, the power module assembly controller 606 may be potted. The power module assembly controller 606, potted or otherwise, may be designed to fit within an interior central cavity of the coil winding assembly 500.

The individual coils 526 may use toroidal winding without end windings and in some embodiments be connected to each other in series. In other embodiments, a three-phase winding may be used where adjacent coils 526 are connected together to form a branch of each phase. For instance, two adjacent coils 526 may be phase A coils, the next two adjacent coils 526 may be phase B coils, and the next two adjacent coils 526 may be phase C coils. This three-phase configuration would then repeat for all individual coils 526 within the coil winding assembly 500. When the coils 526 are energized, the three-phase winding can produce a rotating magnetic field in the air gap around the coil winding assembly 500. The rotating magnetic field interacts with the magnetic field generated by the toroidal magnetic tunnel producing torque and relative movement between the coil winding assembly 500 and the toroidal magnetic tunnel. That is, the brushless motor controller 1204 applies current to the phases in a sequence that continuously imparts torque to turn the magnetic toroidal cylinder 100 in a desired direction, relative to the coil winding assembly 500, in motor mode.

In certain alternate embodiments, the thickness of the magnets comprising the outer magnetic wall 232, and in one embodiment the inner magnetic wall 212, may also be increased to increase the generation of torque. In any event, the contribution to torque from the outer magnetic wall 232, and the inner magnetic wall 212 may, be greater than the contribution from the first axial magnetic wall 222 and the second axial magnetic wall 242 due to the geometry of the cross-section of the magnetic tunnel segments 220, 421 and the varying effect force/radius of the components.

Although the central core 42, coil winding assembly 500, and magnetic toroidal cylinder 100 are illustrated in cross-section as rectangular, any cross-sectional shape may be used depending on the design and performance requirements for a particular electric machine 10.

### Advantages of Certain Embodiments

One of the advantages of this type of configuration over conventional electric motors is that the end turns of the coils 526 are part of the “active section” or force generation section of the electric machine 10. In conventional electric motors, only the axial length of the coils produces power, the end turns of the coils do not produce power and merely add weight and copper losses. However, as explained above, the entirely of the coil 526 is effectively utilized to produce torque because of the side axial magnetic walls 222, 242 or axial magnets. Therefore, for a given amount of copper more torque can be produced compared to a conventional electric motor.

In summation, surrounding the coils 526 with magnets creates more flux density and most of the magnetic forces generated are in the direction of motion so there is little, if any, wasted flux compared to a conventional electric motor. Further, because the forces are now all in the direction of motion more torque is generated and the configuration further minimizes vibration and noise compared to a conventional electric motor where the forces, depending on the polarity of the current in the coil may try and pull the coil downwards or push the coil upwards and therefore not in the direction of motion. Further, continuous torque and continuous power are greatly increased compared to a conventional electric motor as is the motor's torque density and power density by volume and weight. Even further, although the coil winding assembly 500 may be compact, the coils 526 are easily cooled because they are surrounded by an effective heat sink and since there is little to no overlap of the coil windings 526, there is little if any unwanted field induction which also contributes to a more efficient electric motor design.

Torque Tunnel Halbach Array Electric Machine Embodiment

Invented by Klaus Halbach in the 1980s at the Lawrence Berkeley National Laboratory, the Halbach Array is a special arrangement of permanent magnets having a spatially rotating pattern of magnetization that augments the magnetic field strength on one side of the Halbach Array while decreasing the magnetic field strength on the other side of the Halbach Array because the magnetic flux is contained within the magnets of the circuit.

In certain embodiments, a Halbach Array may not require a ferrous back-iron material behind the permanent magnet of the Halbach Array and a lightweight non-magnetic filler material, such as aluminum, carbon fiber, plastic, and the like may be used instead of a ferrous back iron material to reduce weight, although the thickness of the aluminum may have to be increased to provide the necessary structural strength.

In some embodiments, the linear machine 10 may include an array of permanent magnets having different magnetic orientations, that is a Halbach Array, configured to generate a spatially rotating pattern of magnetization. In such an arrangement, the magnetic field strength may be almost doubled on an augmented side and near zero on a diminished side when compared to a conventional array of permanent magnets having the same orientation or an alternating N-S-N-S-N geometry. That is, the Halbach Array is a more efficient use of magnet alloy that may justify the increased difficulty in manufacturing when an air “gap” exists in the application.

FIG. 1G1 illustrates the stand-alone flux field of an array of eight magnets having the same orientation and their stand-alone flux field. In certain embodiments, the Halbach Array of permanent magnets may include four magnets having different magnetic orientations. FIG. 1G2 illustrates the corresponding stand-alone flux field of an array of eight permanent magnets having a spatially rotating pattern of magnetization. Specifically, FIG. 1G2 illustrates a Halbach Array of 4 magnets, forming 2 poles or 1 pole pair, which is repeated twice for a total of 8 magnets, forming 4 poles or two pole pairs. That is, FIG. 1G2 shows a Halbach Array using a somewhat coarse 90-degree orientation change between adjacent magnet elements. A Halbach Array having a smaller angle, such as 45 degrees, will result in a better approximation of a circumferential field orientation at the augmented side of the Halbach Array, which results in more homogenous and thereby stronger flux field, thereby improving the efficiency of the electric motor 10. In one embodiment, the Halbach Array of permanent magnets may include eight magnets having 45 degrees orientation change between adjacent magnets. FIG. 1G3 illustrates the corresponding stand-alone flux field of an array of eight permanent magnets having a 45 degrees orientation change between adjacent magnets as shown in FIG. 1G4. In yet another embodiment, the Halbach Array of permanent magnets may include twenty-four magnets having 15 degrees orientation change between adjacent magnets.

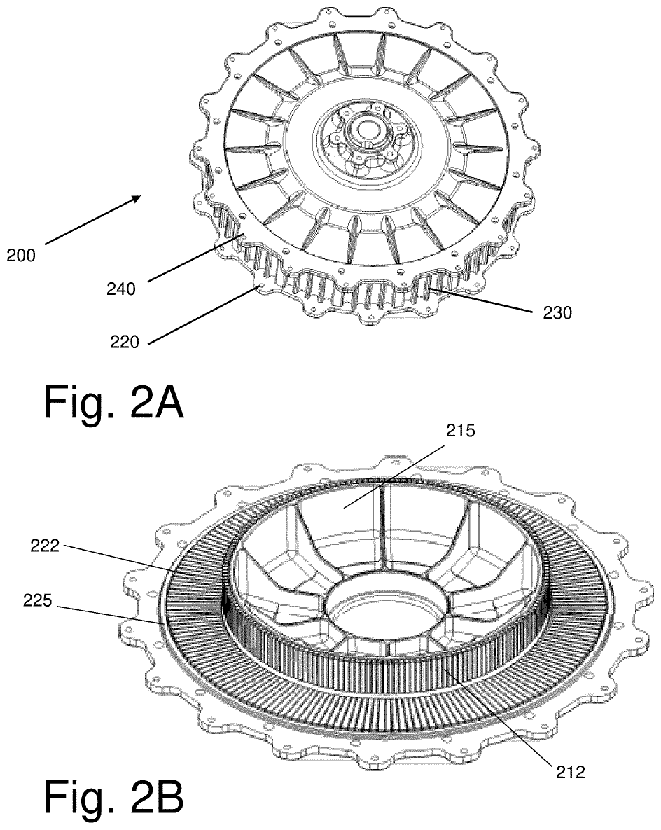

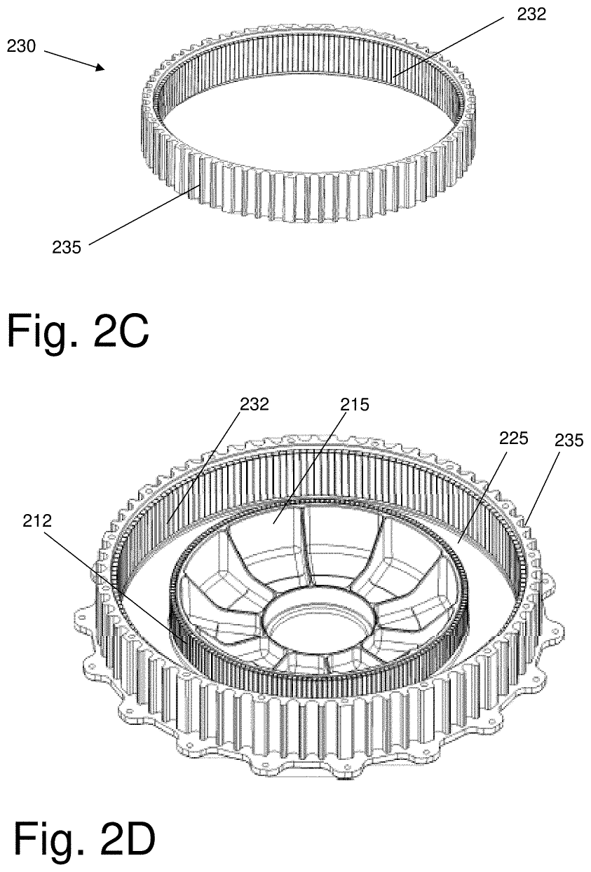

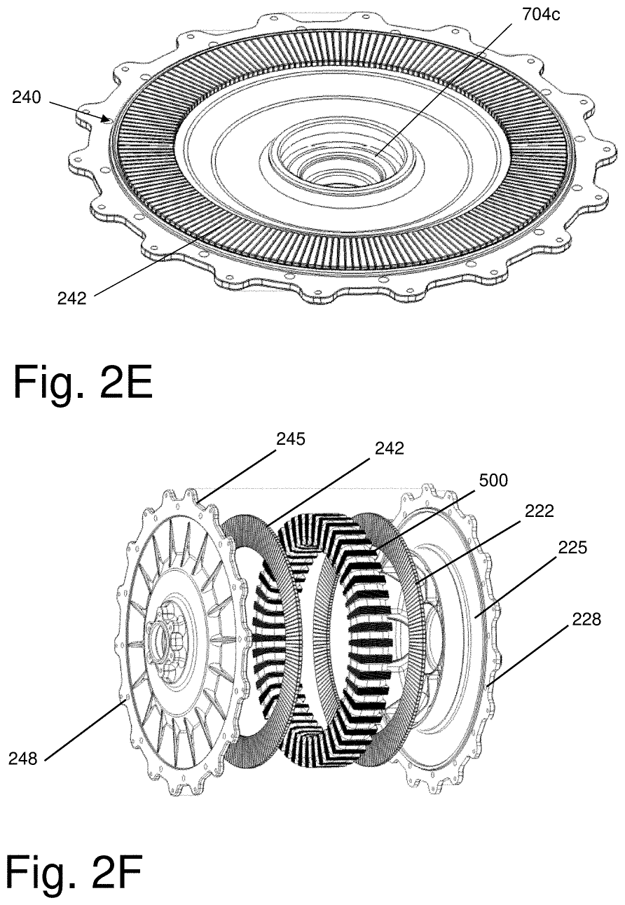

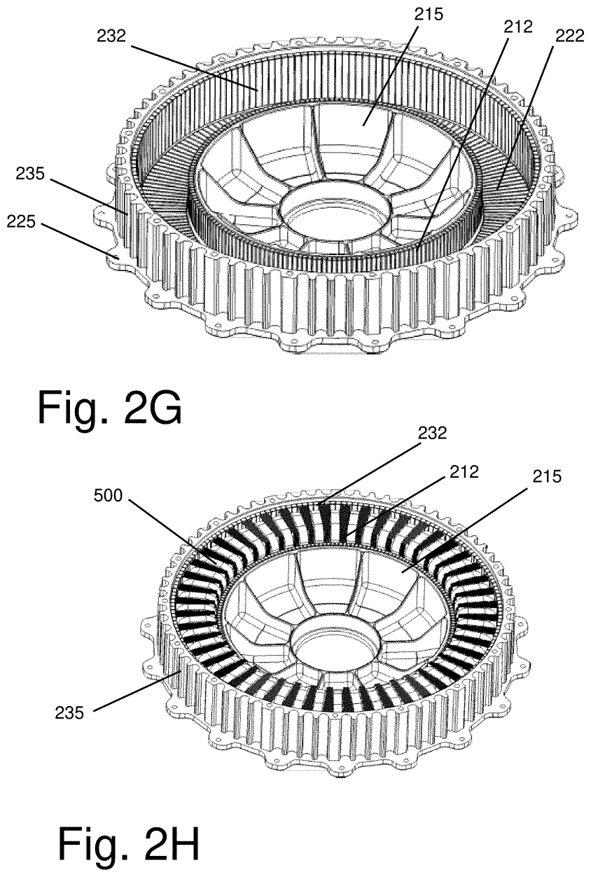

FIG. 2A is an isometric view illustrating one embodiment of a Torque Tunnel Halbach Array Electric Motor (THEM) 200. An alternate use of the same mechanical configuration is as a Torque Tunnel Halbach Array Electric Generator (THEG) where the sequentially switching of a load across the different windings is synchronized to the rotation. In the following embodiments the abbreviation THEM 200 may therefore be extended to mean Torque Tunnel Halbach Array Electric Machine. In the illustrative embodiment of FIG. 2A the THEM 200 may have a plurality of toroidal wound phase coils arranged circumferentially around a common stator core having uniform angular spacing. The plurality of phase coils being encompassed by an inner radial rotor, an outer radial rotor, and two axial rotors having purposely arranged Halbach Array type permanent magnets.

### Advantages of Certain Embodiments

Higher efficiency is always a requirement for electric machines and Flux Density Distribution (FDD) within an electric machine has a significant effect on the electric machine's torque, efficiency, torque ripple, and pulsation performance. Electric machines equipped with Halbach Arrays present some significant advantages over conventional permanent magnet electric machines. For instance, an increased flux density in the air gap, which results in higher levels of torque and torque density. A reduction in the level of magnetic flux density harmonics in the air gap, which results lower levels of torque ripple. An absence of magnetic flux density at the back of the Halbach Array, which results in higher levels of torque density at the front of the Halbach Array. An absence of back-iron material, which results in higher levels of acceleration, once the weight associated with the back-iron material has been removed.

This patent application further discusses novel methods and systems of increasing the flux density in an electric machine through the novel arrangement of multiple rotors having a plurality of flux shaping Halbach Arrays configured to increase the Flux Density Distribution (FDD) in a closed magnetic torque tunnel. Surrounding the coils 526 of the coil winding assembly 500 with Halbach Arrays creates more flux density than a conventional electric machine and most of the magnetic forces generated are in the direction of motion so there is little, if any wasted flux compared to a conventional electric motor. Further, because the forces are now all in the direction of motion more torque is generated and the configuration further minimizes vibration and noise compared to a conventional electric motor where the forces, depending on the polarity of the current in the coil may try and pull the coil downwards or push the coil upwards and therefore not in the direction of motion. Even further, continuous torque and continuous power are greatly increased compared to a conventional electric motor as is the motor's torque density and power density by volume and weight. Yet further, although the coil winding assembly 500 may be compact, the coils 526 are easily cooled because they are surrounded by an effective heat sink and since there is little to no overlap of the coil 526 of the coil winding assembly 500 there is little if any unwanted field induction, which also contributes to a more efficient electric motor design.

Another advantage of an electric machine 10 having multiple rotors is that the end turns of the coils 526 are part of the “active section” or force generation section of the electric machine 10. In contrast, in a conventional electric machine only the axial length of the coils produces power, the end turns of the coils do not produce power and merely add weight and copper losses. In some of the followings embodiments, the entirety of the coil 526 is effectively utilized to produce torque, because the coils 526 of the coil winding assembly 500 are encapsulated in their entirely by the axial magnets of the side axial walls (rotors) and the radial magnets of the inner and outer radial walls (rotors). Therefore, for a given amount of coil copper more torque can be produced by an electric machine 10 having a multiple rotor configuration compared to a conventional electric machine. The result is a very light, very compact electric machine 10 assembly with very smooth commutation and unlatched levels of torque and efficiency.

In some embodiments, the inner rotor assembly 210 may comprise a plurality of inner rotor axial permanent magnets 212 positioned about and coupled to an inner rotor core 215.

In certain embodiments, the inner rotor permanent magnets 212 may be ideal or substantially ideal Halbach Arrays. In practice it may be impractical to use ideal Halbach Arrays and the Halbach Arrays may be constructed with segments of permanent magnets 212 configured to form quasi-Halbach Arrays. In some embodiments, the segments of permanent magnets 212 may be substantially the same size, such that they are arranged circumferentially around the inner rotor core 215 having uniform angularly spacing. In certain embodiments, the angular width of the segments of permanent magnets nearest the poles of the Halbach Arrays may be greater than the angular width of the segments of permanent magnets 212 furthest from the poles of the Halbach Arrays. In either case, the plurality of flux shaping Halbach Arrays are configured to increase the 3D magnetic flux field in the magnetic toroidal cylinder 100, such that the FDD is increased. In theory a Halbach Array, at least an ideal Halbach Array, may not require ferromagnetic back iron material behind the permanent magnets of the Halbach Array. In practice, a back-iron circuit, albeit a smaller back iron circuit, may still be advantageous especially with quasi-Halbach Arrays to improve the overall performance of the THEM 200. Therefore, in certain embodiments, the inner rotor core 215 may be constructed of, at least in part, a ferrous back iron material such that the FDD is increased.

The flux path of each pole pair segment of the THEM 200 can be considered to travel through a magnet 212 having a N pole configuration of the inner rotor assembly 210 across an air gap into the stator and then back across the air gap into an adjacent magnet 212 having a S pole configuration of the inner rotor assembly 210 completing the circuit via the back iron of the inner rotor assembly 210. As the number of poles increases, the length of the flux path is reduced. More importantly, as the number of poles increases the amount of flux traveling between adjacent poles is reduced, which means that less back iron material is required, and therefore the weight of the core of the inner rotor assembly 210 can be reduced or the weight of the central core or yoke 42 can be reduced.

In certain embodiments, the number of pole pairs of the THEM 200 may be increased for the purposes of reducing the weight of the back iron components and therefore the weight of the electric machine 10, which further increases the torque density of the THEM 200.

Ideally the power losses in the THEM 200 should be confined to the copper losses in the coil winding assembly 500 of the stator. However, while the central core or yoke 42 of the coil winding assembly 500 and inner rotor core 215 of the inner rotor assembly 210 of their respective back-iron circuits are not designed to have any current flowing through them they are however conducting loops that experience a changing magnetic field. Therefore, the central core 42 and inner rotor core 215 of the inner rotor assembly 210 will have small currents induced in them that are proportional to the area of the loop formed by their respective back iron circuits. These induced currents are called eddy currents and the losses associated with the eddy currents, and hysteresis, must be added to the copper losses in the coil winding assembly 500 when determining the efficiency of the THEM 200.

Conventional electric motors have conventionally been made with either or both the stator core and the rotor core made of laminated ferromagnetic sheets that have an insulating coating on each side, which are stacked to form a core assembly. The thickness of the laminations is directly related to the level of heat losses produced by the electric motor when operating, which is commonly referred to as eddy current losses. The thinner the laminations, the less the eddy current losses.

In certain embodiments, the thickness of the laminated strips of the THEM 200 may be less than about 2 mm. In one embodiment, the air gap between adjacent laminations is less than about one-half mm thick. In other embodiments, the inner rotor assembly 210 or central core 42 of the THEM 200 may comprise laminated strips of electrical steel separated by a small airgap.

Electrical steel, also known as lamination steel, silicon electrical steel, silicon steel, relay steel, transformer steel, and the like, is an iron alloy tailored to produce specific magnetic properties: small hysteresis area resulting in low power loss per cycle, low core loss, and high permeability. In certain embodiments, the central core 42 may be made from a tape wound magnetic steel. In some embodiments, the material may be Hiperco 50®, Metglas®, Somlaloy®, or even magnetic tape back.

In certain embodiments, the electrical steel sheets may be coated with an electrical insulator to increase electrical resistance between the laminations, to further reduce eddy currents, provide resistance to corrosion or rust, and to act as a lubricant during the die cutting process. In one embodiment, the steel laminations may be coated with an oxide layer. In another embodiment, the steel laminations may be coated with an insulating polyimide sheet, an aromatic nylon sheet, a synthetic fiber sheet, or other non-surface core plating electrically insulating sheet to further reduce the flux and current flow.

In certain embodiments, the steel laminations may be made from a 2D flux path material, such as Cold-rolled Grain-Oriented (CRGO) electrical steel. CRGO electrical steel has a high-silicon level of about 3% (Si:11Fe), which increases the resistivity of the electrical steel to several times that of pure iron.

These laminated stator or rotor structures create a predominately 2D flux path inside the cores for the magnetic flux to follow when the THEM 200 is in operation. Referring once more to the 4-rotor embodiment of FIG. 2A the flux may not act in substantially a single direction. Therefore, 2D flux path material, such CRGO electrical steel laminations used in a conventional electric motor may not be the best choice.

In certain embodiments, a 3D flux path material may be used for the rotor core(s) 215. 225, 235, and 245 and central core 42 of the THEM 200. The 3D flux path material may comprise a soft magnetic composite (SMC) material, for instance ferromagnetic particles that are individually surrounded by an insulative material or film, that, when bonded together into a solid block form a composite material that enables the magnetic flux to flow in any direction throughout the block with low eddy current losses.

Using a ferromagnetic open cell structure would result in an electric machine 10 that is substantially lighter in weight than other electric machines available on the market and enable a significantly higher torque density than existing electric motors whether they be of the 2D or 3D flux path motor architecture type.

In some embodiments, the first axial rotor assembly 220 may comprise a plurality of first axial permanent magnets 222 positioned about and coupled to a first axial inner rotor core 225.

In certain embodiments, the first axial permanent magnets 222 may be ideal or substantially ideal Halbach Arrays. In other embodiments, the Halbach Arrays may be quasi-Halbach Arrays and the first axial rotor core 225 may be constructed, at least in part, of a ferromagnetic back iron material. In either case, the plurality of flux shaping Halbach Arrays are configured to increase the 3D magnetic flux field in the magnetic toroidal cylinder 100.

FIG. 2B is an isometric view illustrating the first axial rotor assembly 225 coupled at an inner edge to a first end of the inner rotor assembly 215. In certain embodiment the inner core 215 and the first axial rotor core 250 may be integral parts of a common casting.

FIG. 2C is an isometric view illustrating an outer rotor assembly 230 of the THEM 200. In some embodiments, the outer rotor assembly 230 may comprise a plurality of outer rotor permanent magnets 232 positioned about and coupled to an outer rotor core 235.

In certain embodiments, the outer rotor permanent magnets 232 may be ideal or substantially ideal Halbach Arrays. In other embodiments, the Halbach Arrays may be quasi-Halbach Arrays and the outer rotor core 235 may be constructed, at least in part, of a ferromagnetic back iron material. In either case, the plurality of flux shaping Halbach Arrays are configured to increase the 3D magnetic flux field in the magnetic toroidal cylinder 100.

FIG. 2D is an isometric view illustrating a THEM 200 having an outer rotor assembly 230 adjacent to an inner rotor assembly 210. That is, FIG. 2D illustrates the rotor assembly of a new class of Torque Tunnel Halbach Array Electric Machine, a Double-rotor Torque Tunnel Halbach Array Electric Machine (DTHEM) having a single Halbach Array coil winding assembly 500 (not shown). Specifically, FIG. 2D illustrates a radial DTHEM. The radial DTHEM of FIG. 2D may be ideal for applications where the total length is not constrained, such as a longitudinal or inline motor configuration.

FIG. 2E is an isometric view illustrating a second axial rotor assembly 240 of the THEM 200. In some embodiments, the second axial rotor assembly 240 may comprise a plurality of second axial rotor permanent magnets 242 positioned about and coupled to a second axial rotor core 245.

FIG. 2F is an isometric view illustrating a THEM 200 having a first axial rotor assembly 220 and a second axial rotor assembly 240. That is, FIG. 2F illustrates the rotor assembly of a new class of Torque Tunnel Halbach Array Electric Machine, a Double-rotor Torque Tunnel Halbach Array Electric Machine (DTHEM) having a single Halbach Array coil winding assembly 500 (not shown). Specifically, FIG. 2E illustrates an axial DTHEM. The axial DTHEM of FIG. 2F may be ideal for applications where the total length is constrained, like a direct drive hub of an electric vehicle or a transverse motor configuration.

In some embodiments, a double rotor configuration, be it radial DTHEM (FIG. 2D) or axial DTHEM (FIG. 2F), may achieve a greater maximum phase flux linkage (λmax) for a given volume than a conventional electric machine having a single rotor. A double rotor configuration may therefore be a more efficient configuration in terms of torque and motor efficiency compared to a convention electric machine. Another advantage of having multiple rotors, be it two, three, or four, is that their higher inertia makes them better suited for pulsating loads, such as reciprocal compressors. In certain embodiments, the first axial rotor assembly 210 and the second axial rotor assembly 230 may include one or more threaded receptacles 228 and 248 respectively.

FIG. 2G is an isometric view illustrating the first axial rotor assembly 220 and inner rotor assembly 210 of FIG. 2B coupled to the outer rotor assembly 230 of FIG. 2C. That is, FIG. 2G illustrates the rotor assembly of a new class of THEM 200, a Triple Rotor Torque Tunnel Halbach Array Electric Machine (TTHEM) having a single Halbach Array coil winding assembly 500 (not shown). A TTHEM configuration offers advantages over a conventional electric machine in terms of torque and motor efficiency.

FIG. 2H is an isometric view illustrating a coil winding assembly within the rotor assembly of FIG. 2G. In some embodiments, the rotating sinusoidal Magnetic Force (MMF) of the THEM 200 may be produced by the coil winding assembly 500 described above for torque production.

In certain embodiments each of the Halbach Arrays of the THEM 200 may be formed of 4 permanent magnets having different magnetic orientations configured to form a Halbach Array having 2 poles or a single pole pair. In one embodiment each of the Halbach Arrays may be formed of 8 permanent magnets having different magnetic orientations configured to form a Halbach Array having 2 poles or a single pole pair. The configuration of permanent magnets of each Halbach Array may be repeated about the inner rotor core 215 of the inner rotor assembly 210 and outer rotor core 235 of the outer rotor core assembly 230 a number of times. The associated 3-phase coil Halbach Array coil winding assembly 500 may include a sequential sequence of phase-A coils 526, phase-B coils 526, and phase-C coils 526 and the arrangement may be repeated for the length of the stator of the THEM 200.

In certain embodiments each coil 526 may comprise a single turn of conducting wire. In another embodiment each coil 526 may comprise a plurality of turns of conductive wire. In either case, the conducting wire may have a square shape cross section for a higher packing factor

Referring once more to the embodiment of FIG. 2A, FIG. 2A is an isometric view of a THEM 200 according to the principles of the present invention having four rotors surrounding a coil winding assembly 500 having a plurality of stator poles or flux concentrators 34. That is, FIG. 2A illustrates a new class of THEM 200, a Quadruple rotor Torque Tunnel Halbach Array Electric Machine (QTHEM) where certain embodiments utilize one or more Halbach Arrays in all or a portion of the four rotors having a single Halbach Array coil winding assembly 500.

The result is a novel ironless electric permanent magnet electric machine design using the Halbach Array and a magnetic torque tunnel with high power density, high torque, high specific power, and low power losses, even when operating at high revolutions per minute that are especially suitable for weight and volume sensitive applications, such as mobile electric vehicles.

In order maintain the generated torque and/or power the individual coils 526 in the Halbach Array coil winding assembly 500 may be selectively energized or activated by way of a high-power electronic switching system or brushless motor controller 1204. In order to maintain rotation adjacent coils 526 may be powered up in turn. For instance, the brushless motor controller 1204 may cause current to flow within the individual coil 526 when the individual coil 526 is within a magnetic tunnel segment with a NNNN magnetic pole configuration. On the other hand when the same individual coil moves into an adjacent magnetic tunnel segment with a SSSS magnetic pole configuration, the brushless motor controller 1204 causes the current within the individual coil 526 to flow in the opposite direction so that the generated magnetic force is always in same direction.

The individual coils 526 may use toroidal winding without end windings and in some embodiments be connected to each other in series to form a single-phase stator assembly. In other embodiments, the electrical coils 526 may be connected in an array of separately connected series coils 526 to form a polyphase stator assembly. In certain embodiments, a three-phase winding may be used where adjacent coils 526 are connected together to form a branch of each phase. The coils 526 may be electrically separated from each other and controlled independently. The rotating magnetic field interacts with the magnetic field generated by the toroidal magnetic tunnel producing torque and relative movement between the Halbach Array coil winding assembly 500 and the toroidal magnetic tunnel. That is, the brushless motor controller 1204 applies current to the phases in a sequence that continuously imparts torque to turn the magnetic toroidal cylinder 100 in a desired direction, relative to the Halbach Array coil winding assembly 500, in motor mode.

The foregoing description of the embodiments of the invention has been presented for the purposes of illustration and description. It is not intended to be exhaustive or to limit the invention to the precise form disclosed. Many combinations, modifications and variations are possible in light of the above teaching. For instance, in certain embodiments, each of the above described components and features may be individually or sequentially combined with other components or features and still be within the scope of the present invention. Undescribed embodiments which have interchanged components are still within the scope of the present invention. It is intended that the scope of the invention be limited not by this detailed description, but rather by the claims.

What is claimed is:

1. A method for winding a heavy gauge toroidal coil of an electric machine, the method comprising:
pre-cutting a heavy gauge wire to a length determined by a desired number of coil turns;
positioning about a middle of the pre-cut heavy gauge wire in contact with a chamfer in a face of a center projection of a fixture tool, wherein the chamfer is inclined at an angle between adjoining right-angle faces of the center projection of the fixture tool;
bending the heavy gauge wire in a first direction using the center projection to compete the first turn of the winding process, wherein both ends of the heavy gauge toroidal coil are wound simultaneously starting from about the middle of the coil about the fixture tool;
bending the heavy gauge wire in a seconding direction using the center projection to complete the second turn of the winding process; wherein both ends of the heavy gauge toroidal coil are wound simultaneously;
continuing to bend the heavy gauge wire in the first direction and the seconding direction simultaneously until a required number of even turns of the coil or a required number of odd turns of the coil are completed;
removing one of the adjoining right-angled faces of the fixture tool; and
sliding the coiled heavy gauge wire off of the center projection of the fixture tool by means of one of the removed adjoining right-angle faces.

2. A Torque Tunnel Halbach Array electric machine comprising:
a magnetic toroidal cylinder including;
an inner rotor assembly, the inner rotor assembly comprising a plurality of inner permanent magnets positioned about and coupled to an inner rotor core, wherein the plurality of inner permanent magnets form a plurality of flux shaping Halbach Arrays configured to focus the Flux Density Distribution (FDD) in the magnetic toroidal cylinder;
a first axial rotor assembly, the first axial rotor assembly comprising a plurality of permanent magnets positioned about and coupled to a first axial rotor core, wherein the plurality of first axial permanent magnets form a plurality of flux shaping Halbach Arrays configured to focus the FDD in the magnetic toroidal cylinder, the first axial rotor assembly coupled at an inner edge to a first end of inner rotor assembly;
a second axial rotor assembly, the second axial rotor assembly comprising a plurality of permanent magnets positioned about and coupled to a second axial rotor core, wherein the plurality of second axial permanent magnets form a plurality of flux shaping Halbach Arrays configured to focus the FDD in the magnetic toroidal cylinder, the second axial rotor assembly coupled at an inner edge to a second end of the inner rotor assembly; such that, the rotor core assemblies form a three sided magnetic torque tunnel comprising at least a first magnetic pole tunnel segment and a second magnetic pole tunnel segment, and
a coil winding assembly positioned within the magnetic toroidal cylinder, the coil winding assembly including a plurality of coils, wherein the first or second magnetic pole tunnel segment surround at least one of the plurality of coils.
